(19) United States
(12) Patent Application Publication
(10) Pub. No.: US 2009/0005196 A1
(43) Pub. Date: Jan. 1, 2009

(54) Court-based game played by players riding vehicles

(75) Inventors: James J. Kessler, Winter Garden, FL (US); Stephen J. Kessler, Amherst, NY (US); Jason E. Bock, Williamsville, NY (US); Michael J. Palumbo, East Amherst, NY (US); Joseph Scinta, Tonawanda, NY (US)

Correspondence Address: SIMPSON & SIMPSON, PLLC, 5555 MAIN STREET, WILLIAMSVILLE, NY, 14221-5406, US

(73) Assignee: Cyber Sport Manufacturing LLC, Amherst, NY (US)

(21) Appl. No.: 11/824,179

(22) Filed: Jun. 27, 2007

(51) Int. Cl. A63B 67/00; B60K 26/00; B60R 19/02; B62D 63/04

(52) U.S. Cl. 473/476; 180/333; 280/32.7; 293/102

(57) ABSTRACT

A game having a floor, a plurality of walls rising up from said floor defining a play area, a game piece, at least one target positioned proximate the plurality of walls, including a plurality of multi-planar apertures operatively arranged to accept the game piece, and a vehicle, operatively arranged to be driven by a player, the vehicle having a bumper positioned circumferentially about a base of the vehicle.

### CROSS-REFERENCE TO RELATED APPLICATIONS

This application is a Continuation-in-Part of a PCT Application titled “COURT-BASED GAME PLAYED BY PLAYERS RIDING VEHICLES,” filed on Jun. 27, 2007, which application is incorporated herein by reference.

### REFERENCE TO COMPUTER PROGRAM LISTING/TABLE APPENDIX

The present application includes a computer program listing appendix on compact disc. Two duplicate compact discs are provided herewith. Each compact disc contains a plurality of files of the computer program listing as follows: Converted to ASCII Files:

| Name | Size | Created |
|---|---|---|
| car_software.txt | 532 KB | 06/18/2007 11:18:22 AM |
| goal_software.txt | 949 KB | 06/18/2007 10:45:06 AM |

The computer program listing appendix is hereby expressly incorporated by reference in the present application.

### FIELD OF THE INVENTION

The invention relates generally to games played by players riding vehicles, specifically to games involving teams of players riding vehicles on a court, having an object of scoring by passing a projectile through a wall mounted, multi-planar goal.

### BACKGROUND OF THE INVENTION

Games played upon a hard surface with players riding personal vehicles are known in the art. Specifically, U.S. Pat. No. 4,387,898 (Mangum et al.) describes a ball game played upon hard surface with players each riding their own vehicle. The players pass the ball with scoops held in one hand and drive the personal vehicle with the other hand. The game includes only a single, planar goal positioned at each end of the playing field. This design severely limits the amount of useable floor space for positioning the vehicles around the entire playing field and promotes “crowding” of players to a central area of the playing field. Furthermore, the personal vehicles described by Mangum et al. feature crank-like steering which is unwieldy with one hand and offers clumsy maneuverability. Other deficiencies of the game described by Magnum et al. include a perimeter wall that can operatively trap the ball, making it difficult to achieve continuous game play. The game taught by Mangum et al. also has a skirt around the perimeter of the floor that uses planks of wood or metal with large springs between the skirt and the wall. This bumper system creates a gap between the planks and the wall in which the ball could get stuck or a player could get injured. Finally, although these vehicles are self-propelled the vehicles are powered by current running through strips of metal embedded in the floor. Therefore every vehicle is either active or inactive at the same time.

Games are also known in the art which utilize multi-planar goals. Specifically, U.S. Pat. No. 3,415,522 (Bauer) discloses a field game comprising two sets of three goals positioned on opposing ends of a playing field. The first goal has an opening positioned downfield towards the opposing first goal. The second and third goals are positioned at outward angles, to the left and right sides of the playing field, respectively. However, the goals in Bauer are located at ground level only, and the game itself is played in an open field. It also does not utilize vehicles which the players use to maneuver around the field.

### BRIEF SUMMARY OF THE INVENTION

The present invention broadly comprises a game having a floor, a plurality of walls rising up from the floor defining a play area, a game piece, at least one target positioned proximate the plurality of walls, including a plurality of multi-planar apertures operatively arranged to accept the game piece, and a vehicle, operatively arranged to be driven by a player, the vehicle having a base, a seat, a movement control device positioned atop the base and in front of the seat, and a bumper positioned circumferentially about the base, and wherein the movement control device is operatively arranged to electronically control a turning means of the vehicle and electronically control a drive means of the vehicle. In a preferred embodiment the game is played on a court having a floor, four walls and a ceiling, with a pair of goals mounted on opposing walls proximate the ceiling.

The present invention further comprises a control terminal which is operated by a game referee. The control terminal can display and store game statistics such as the score, number of shots taken by each player, number of passes by each player, number of rebounds by each player, and so on. It can also play pre-recorded audio messages or music which correspond with the inputs the referee enters into the control terminal. Furthermore the control terminal may be used to control the speed of individual vehicles, disable or enable the drive mechanisms for the entire play area, turn on and off lights, and monitor power levels of onboard power supplies for individual vehicles.

The present invention also broadly comprises a control terminal including a computer-based method for controlling a plurality of independently propelled vehicles and at least one target. In a preferred embodiment, the method further includes a means for recording and displaying at least one characteristic of the game. In some aspects, the at least one characteristic of the game is selected from the group consisting of: scores, shots, penalties, player names, and time. In a further preferred embodiment, the at least one characteristic of the game is entered into the control terminal by means of a touch screen monitor. The control terminal may further include a means for operating an audiovisual output and a means for calculating at least one statistical characteristic of the game.

In a preferred embodiment, the control terminal includes a means for controlling the drive means of the vehicle and wherein the means for controlling the drive means of the vehicle is operatively arranged to control a rate of movement of the vehicle.

It is a general object of the present invention to provide a new and improved game for a plurality of players to participate in.

It is another object of the present invention to provide a safe bumper-car style vehicle to enhance game play.

It is a further object of the present invention to create a bumper system that protects players from being injured if a hand, foot, or other body part gets caught between two bumpers.

It is another object of the present invention to create a skirt around the perimeter of a play area for the aforementioned game which deflects a game piece back into the middle of the play area.

It is yet another object of the present invention to provide a multi-planar goal system to increase the strategy involved in playing the aforementioned game, and to spread players more evenly throughout the play area.

It is yet another object of the present invention to provide a vehicle for the aforementioned game which is variable in speed and turning to create a more intense game play experience.

It is yet a further object of the present invention to provide a control terminal to monitor and control all desired aspects of the aforementioned game from one location.

It is yet a further object of the present invention to provide a game where the game referee can interact with a control terminal to play audio messages corresponding with real time actions of the players in the game.

It is a general object of the present invention to provide a method and apparatus for controlling a plurality of independently propelled vehicles.

It is another object of the present invention to provide a method and apparatus for controlling at least one target.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a game being played between two teams of four players each with part of a wall removed to reveal the game;

FIG. 2a is a perspective view of a portion of the left side of the play area of the game;

FIG. 2b is a section view of a wall skirt taken generally along line 2b-2b in FIG. 2a;

FIG. 2c is a section view of the wall skirt and the wall bumper as seen in FIG. 2b with a bumper on a vehicle colliding with the wall bumper;

FIG. 2d is a section view of the wall skirt seen in FIG. 2b illustrating a ball rolling back into the play area off the wall skirt;

FIG. 3 is a perspective view of a vehicle;

FIG. 4 is a partial view of the area encircled in FIG. 3 illustrating an embodiment utilizing a joystick as a movement control means;

FIG. 5 is a section view taken generally along line 5-5 in FIG. 4 illustrating a movement control means;

FIG. 6 is a partial view of the joystick being operated by only the tips of a player's fingers;

FIG. 7a is a perspective view of a scoop;

FIG. 7b is a perspective view of the scoop in FIG. 7a with a ball resting in the scoop's basket portion;

FIG. 8 is a perspective view of a vehicle with a vehicle bumper membrane removed;

FIG. 9 is a perspective view of vehicle bumper membrane which fits around a vehicle bumper cushion on the vehicle;

FIG. 10 is a section view of a vehicle bumper taken generally along line 10-10 in FIG. 3;

FIG. 11 is a perspective view of a goal;

FIG. 11a is a section view of a goal taken generally along line 11a-11a in FIG. 11, showing the inside of the goal;

FIG. 12 is a perspective view of the back of a vehicle showing a pair of motors and a battery pack;

FIG. 13 is a bottom view of a vehicle revealing the components that the vehicle drives on;

FIG. 14 is a partial view of a game utilizing a football as the game piece;

FIG. 15 is a partial view of a game utilizing a backboard and hoop, and a beach ball as the game piece;

FIG. 16 is a perspective view of an alternate embodiment of a goal, which has a rectangular cross-section;

FIG. 17 is a perspective view of a further alternate embodiment of a goal, which has a semi-circular cross-section;

FIGS. 18A-18Y together are a schematic of the electronic circuit in a vehicle;

FIGS. 19A-19Y together are a schematic of the electronic circuit in a goal;

FIG. 20 is a composite of FIGS. 18A-18Y;

FIG. 21 is a composite of FIGS. 19A-19Y;

FIG. 22 is a block diagram illustrating a present invention control terminal for controlling a game;

FIG. 23 is a screen capture illustrating an operation mode selection prompt;

FIG. 24 is a screen capture illustrating a game format selection prompt;

FIG. 25 is a screen capture illustrating a player edit mode;

FIG. 26 is a screen capture illustrating a player designation mode;

FIG. 27 is a screen capture illustrating an active play mode; and,

FIG. 28 is a screen capture illustrating an edit play mode.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects. Also, the adjectives, “front,” “back,” “left,” “right,” “top,” and “bottom ” and their derivatives, in the description herebelow, refer to the perspective of one facing the invention as it is shown in the Figure under discussion. Furthermore, “vehicle” may be used interchangeably with “car.” Likewise, “control terminal” may be used interchangeably with “host.”

Furthermore, it should be understood that this invention is not limited to the particular methodology, materials and modifications described and as such may, of course, vary. It should also be understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

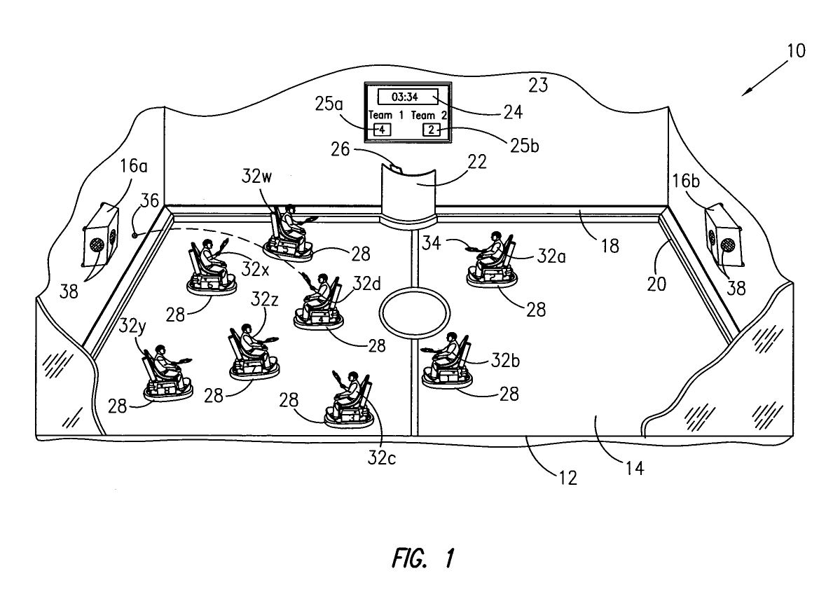

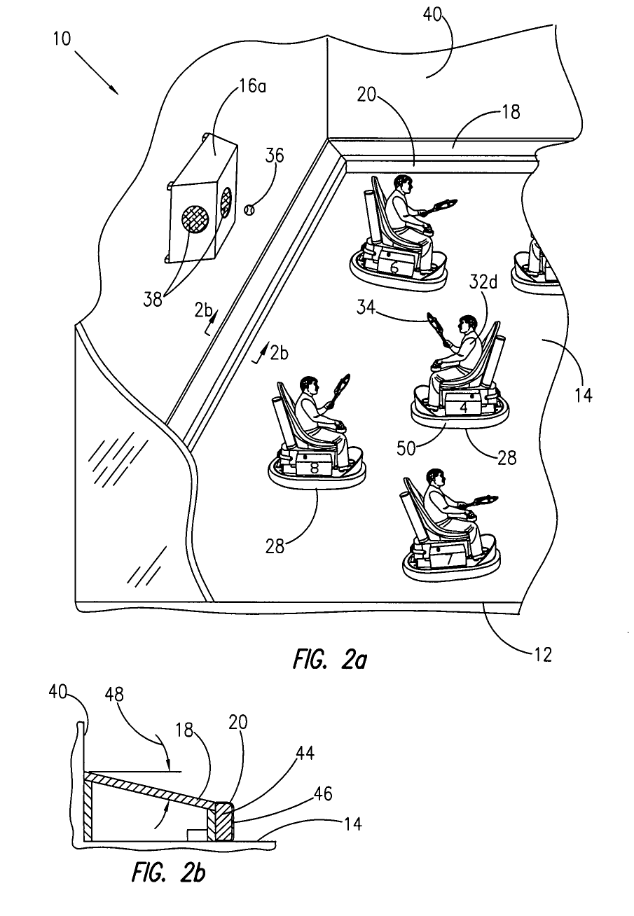

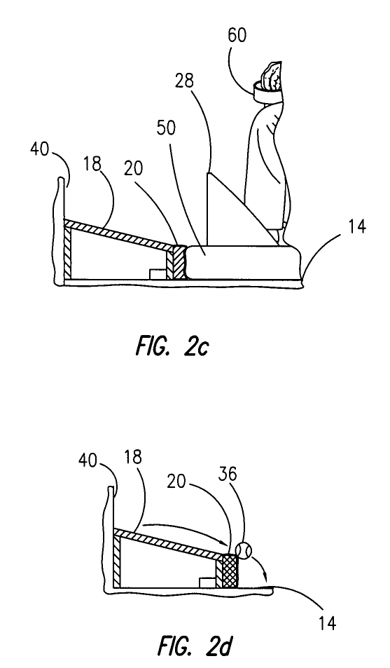

Adverting now to the drawings, FIGS. 1 and 2a illustrate game 10 being played. The game is played in play area 12 which includes floor 14 enclosed by walls 40. Walls 40 should be of a sufficient height to keep the ball in play under normal circumstances, and to define boundaries for the movement of the vehicles. In a preferred embodiment, play area 12 is rectangular, and therefore so is floor 14. However, it should be appreciated that the play area could be any size or shape, including but not limited to circular, triangular, or trapezoidal. The floor is preferably a flat and hard surface such as concrete. It is also preferred that the entire play area be enclosed to prevent the game piece from leaving the play area, and also to provide additional game play strategies which may involve purposefully playing the game piece off the walls. Therefore, walls 40 preferably includes four sides in embodiments which have rectangular play areas, and as many sides as necessary to enclose play areas of other shapes. Around the perimeter of play area 12, at the edge where floor 14 meets wall 40, is wall skirt 18 which terminates in wall bumper 20. In a preferred embodiment, the game is played on a court having a floor, four walls and a ceiling, where the walls form a rectangular play area.

In a preferred embodiment, the game is shown being played by two teams of four players each. The first team comprises players 32a, 32b, 32c, and 32d. The second team comprises players 32w, 32x, 32y, and 32z. It should be appreciated that four players is only used to represent one embodiment of the game. Other embodiments could include more or fewer players, and furthermore, other embodiments could include more than two teams. The vehicles are preferably split into two colored groups (e.g., blue and red teams), and all players on the same team ride vehicles which are the same color. (In a preferred embodiment, the team colors are indicated by LED displays on each car, although team colors could be indicated by car color or by flags affixed to the cars, etc.) Goals 16a and 16b are at opposite sides of the play area. Target apertures 38 are located in each goal 16a and 16b. At the halfway point between the two goals on the play area, preferably against the walls, is shield 22, behind which a referee stands to operate control terminal 26. Scoreboard 23 should be located in an easily visible spot, such as above the control terminal. The scoreboard includes game clock 24 which displays the time remaining in the game, first team score 25a which displays the number of points the first team has scored, and second team score 25b which displays the number of points the second team has scored.

Each player is shown riding vehicle 28 and holding a scoop 34 which is operatively arranged for carrying, passing, and shooting ball 36. Ball 36 is the preferred game piece used to play game 10, but other game pieces of various sizes and shapes may be substituted as described infra. In some aspects, ball 36 is about the size of a baseball and made of a soft, spongy foam material.

FIG. 2b shows a section view of wall skirt 18 and wall bumper 20. The top of wall skirt 18 is sloped at angle 48 below the horizontal. Wall bumper 20 includes wall cushion 44 encased in wall bumper membrane 46. Wall cushion 44 is preferably constructed of high impact, dense foam rubber. Wall bumper membrane 46 is preferably made from a smooth, flexible rubber, the advantages of which will be described infra. In FIG. 2c the wall bumper is shown in contact with vehicle bumper 50 on vehicle 28. FIG. 2d shows ball 36 rolling off of wall skirt 18 over wall bumper 20 and ultimately onto floor 14.

FIG. 3 illustrates vehicle 28 which includes vehicle base 74 upon which seat 52 rests supported by seat support 54. Seat 52 has seatbelt 53. Leg guard 80 is located at the front of vehicle 28 to help ensure that each player's legs stay inside vehicle 28 so that they do not dangle out of the vehicle, where they could get injured. Base 74 of vehicle 28 is surrounded by bumper 50. Motor 92L and battery pack 56 are shown at the back of vehicle 28. Movement control support 58 is located in front of seat 52 located centrally along the width of vehicle 28 protruding out of base 74. Joystick shroud 60 surrounds joystick 62 at the top of joystick support 58. The advantages of the joystick shroud will be described infra.

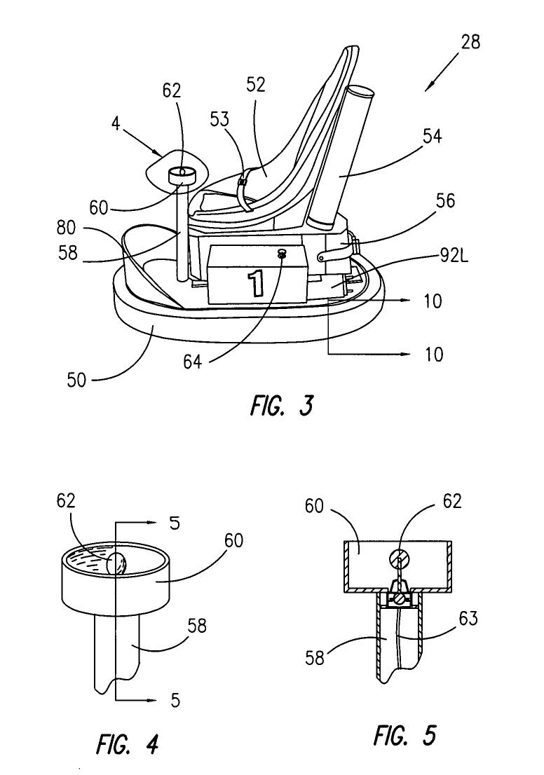

FIG. 4 shows an enlarged view of the joystick and corresponding shroud. FIG. 5 shows a section view of the joystick, shroud, and support further illustrating wiring 63 which connects joystick 62 to the motors 92L and 92R and allows the joystick to communicate with the motors. FIG. 6 shows how only fingers 68 of hand 66 can reach around shroud 60 to operate joystick 62.

It should be appreciated that although joystick 62 is the preferred method of vehicle movement control, other methods may also be acceptable. These other methods may include, but are not limited to a trackball, touch pad, computer style mouse, or electronic keypad. Movement control support 58 may also include a variable height mechanism so that a player can adjust the movement controls to a desired height.

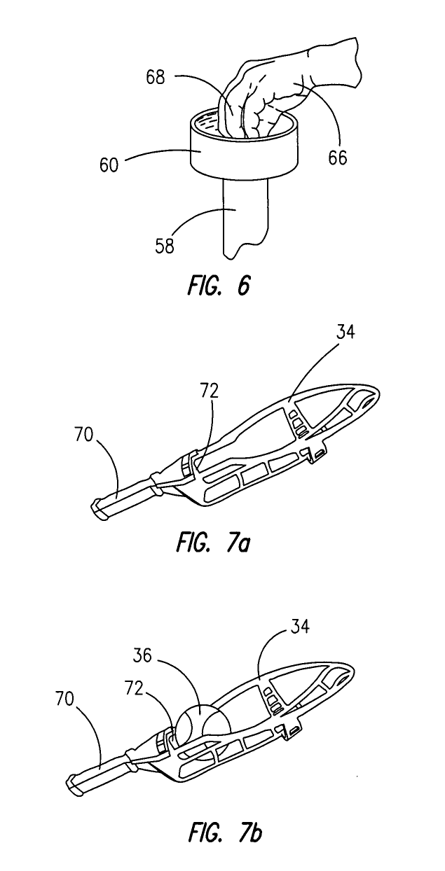

FIGS. 7a and 7b show the scoop with and without the ball, respectively. Scoop 34 has a handle portion 70 for a player to grasp and a basket portion 72 in which the ball can be caught, and from which the ball can be passed or shot. The scoop can be used essentially to retrieve the ball off the ground, catch the ball in mid air, block the ball, pass the ball, or shoot the ball.

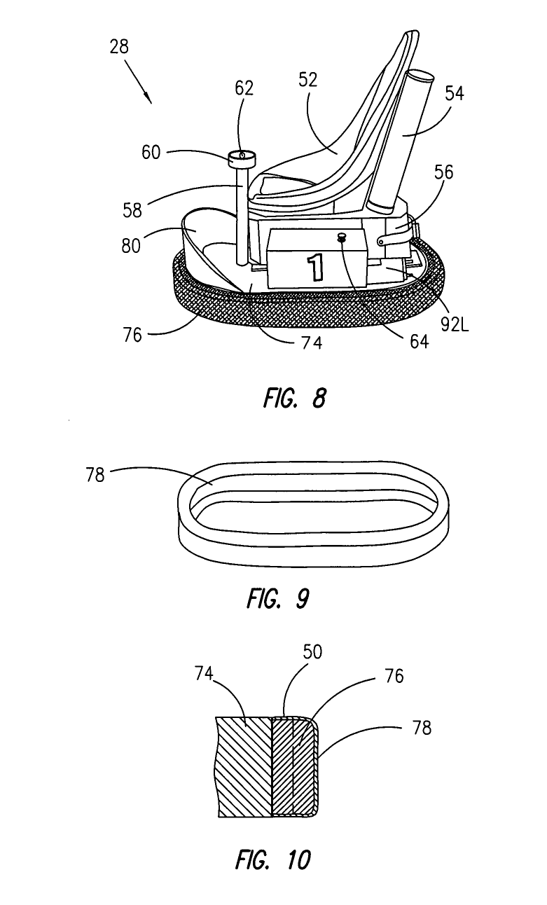

The vehicle and its bumper are illustrated in FIGS. 8-10. FIG. 8 illustrates a similar view of the vehicle as was described with respect to FIG. 3, however the vehicle does not have vehicle bumper membrane 78 secured around inner cushion 76. Vehicle bumper cushion 76 is built the same as wall cushion 44 in wall bumper 20 but sized and shaped to fit around the perimeter of vehicle 28. Vehicle bumper membrane 78 is built the same as membrane 46 but is sized and shaped to fit around vehicle bumper cushion 76.

FIG. 9 shows vehicle bumper membrane 78 which typically is secured around inner cushion 76. The arrangement of the vehicle bumper membrane and the vehicle bumper cushion is further demonstrated in FIG. 10, which shows a cross-section of the vehicle bumper, in which it can be seen that vehicle bumper cushion 76 is affixed to base 74 and encased in vehicle bumper membrane 78.

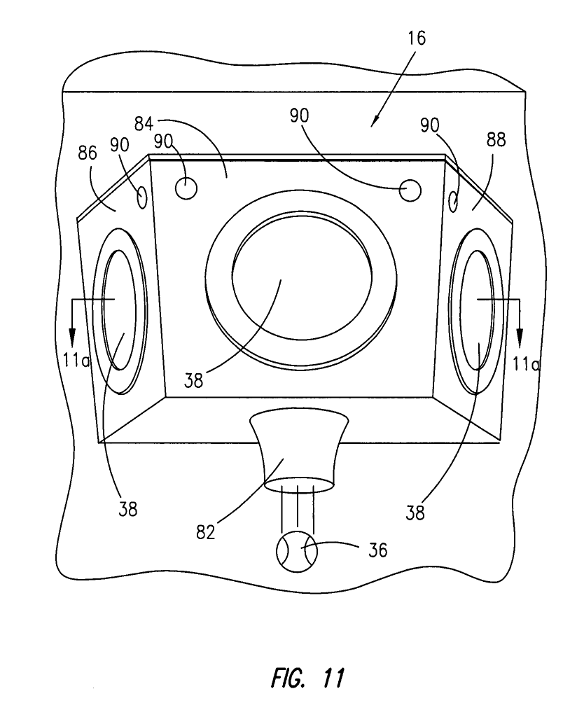

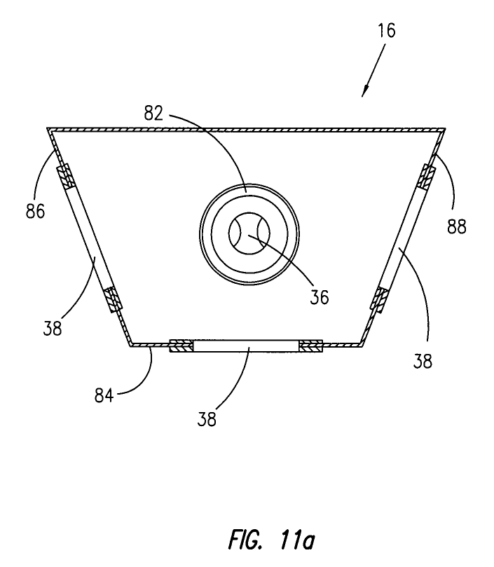

FIGS. 11 and 11a illustrate a preferred embodiment of goal 16 showing a perspective view and a cross-sectional view, respectively. Goals 16a and 16b are comparable to goal 16, and have different reference numerals only to illustrate the respective goals during game play. Therefore, anything said about goal 16 also holds true for both goals 16a and 16b. In these views, goal 16 is shown having three faces 84, 86, and 88, each in its own unique plane generally in the shape of a box with a trapezoidal cross-section. Target apertures 38 are located in each face 84, 86, and 88. Chute 82 is located in the bottom of goal 16 for depositing the game piece, such as ball 36 as shown, back into play. In some embodiments the bottom of the goals may be sloped inward to ensure the ball falls out of the chute.

Each of the faces also preferably has at least one goal indicator. Indicator light 90 can be triggered to illuminate during various events during game play, particularly when a goal is scored. Other events that may trigger indicator light 90 illuminating may include the start or end of a game. Indicator light 90 is preferably a LED or a group of LEDs. They may be any color, but are preferably colored to correspond with the color of the team that is trying to score in the goal that the indicator lights are located on. In some aspects, the teams are trying to score in goals that have indicator lights of the opposite team's color. In other aspects, the indicator lights are colors that do not correspond to either team.

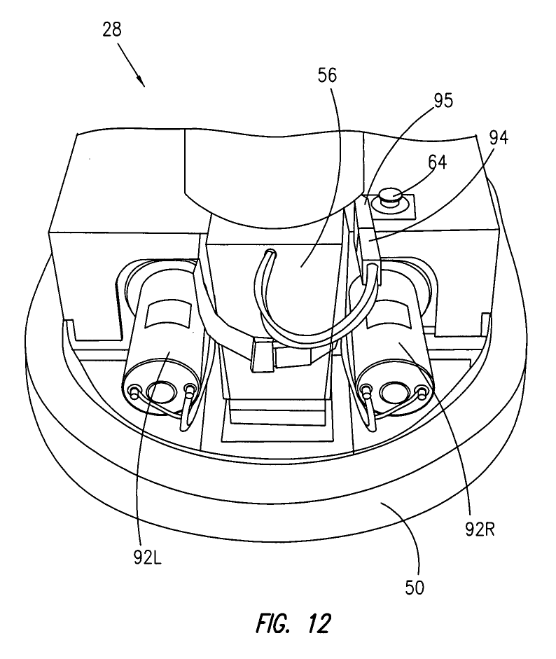

FIG. 12 is rear view of vehicle 28. Motors 92L and 92R are shown positioned on the back left and back right sides of the vehicle, respectively. Emergency stop button 64 is located on the right side of the vehicle above motor 92R. Battery pack 56 detachably fits between motors 92L and 92R. Battery pack 56 powers vehicle 28 when plug 94 is connected to socket 95 on vehicle 28, however, any power source known in the art could be used. In a preferred embodiment, battery pack 56 is used because it is rechargeable, portable, and does not emit harmful gases or fumes. Emergency stop button 64 triggers the connection from the power source to the motors to physically disconnect so that power is no longer transmitted to the motors, thereby stopping the vehicle.

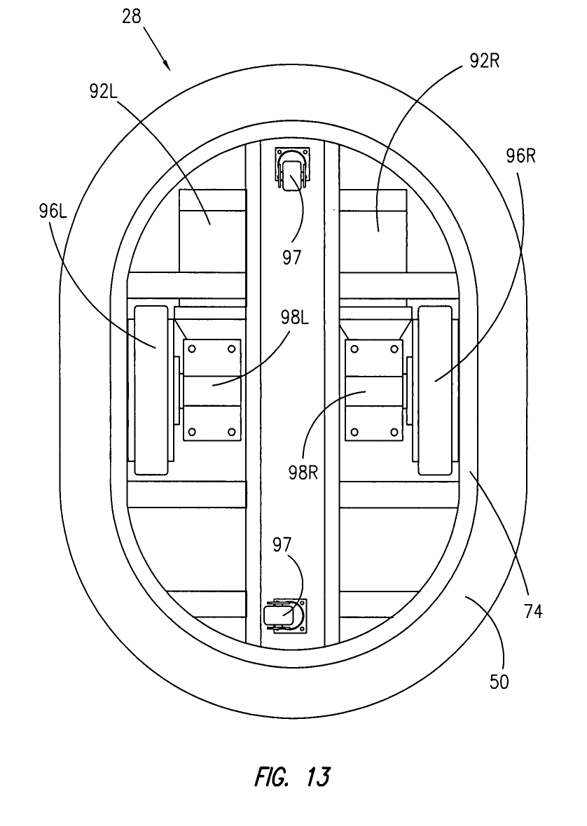

FIG. 13 shows a bottom view of vehicle 28. This reveals casters 27 located at the front and back of vehicle 28 substantially equidistant from the right and left sides of the vehicle. Casters 27 roll and swivel freely, and act only as rolling support for the vehicle, as they are not powered. On the left side of the vehicle is left motor 92L, left wheel 96L, and left drive regulator 98L. On the right side of the vehicle is right motor 92R, right wheel 96R, and right drive regulator 98R. In this embodiment, the motors are rotating about an axis that is perpendicular to that of the axes of the wheels. Drive regulators 98L and 98R take the output from the motors and converts it so that it rotates in the same axes as the wheels so that the vehicle can move. This could be accomplished by the use of a set of bevel gears, but could also be accomplished by any other method known in the art. The drive means may also contain a further system for scaling the output of the motor. For example, the drive means could use a gearing system to take a high rpm output from the motors and convert it to a lower rpm output for the wheels.

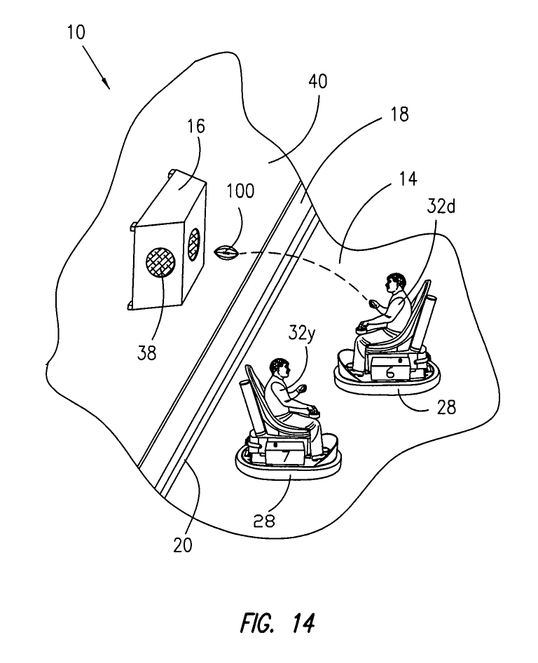

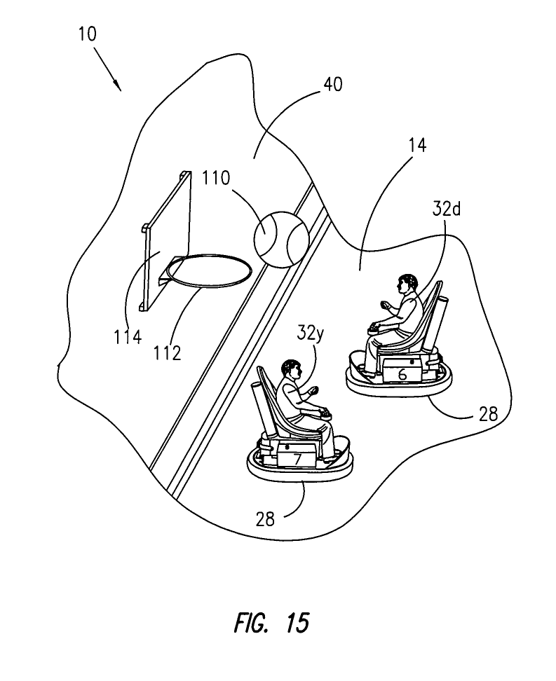

FIG. 14 illustrates another embodiment of game 10 wherein an ellipsoidal game piece, such as football 100, is used instead of ball 36. This embodiment does not require the players to use scoops 34, since the ellipsoidal game piece is thrown and caught with the player's hands. FIG. 15 shows a further embodiment in which goal 16 is replaced by backboard 114 and hoop 112 for a style of game play similar to basketball. In this embodiment, a preferably large spherical game piece is used, such as beach ball 110.

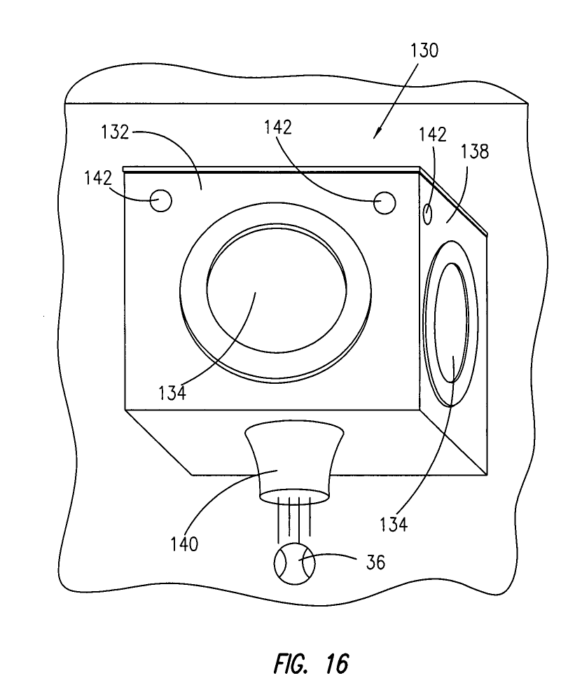

FIG. 16 illustrates another embodiment for the goal. Goal 130 is shaped essentially as an empty cube having three faces 132, 136 (not shown), and 138. Faces 136 and 138 are substantially orthogonal to face 132 and parallel to each other. Each has a target aperture 134 located in it for receiving the game piece. The faces each have at least one light indicator 142 thereon. Light indicator 142 is identical in construction and purpose to light indicator 90 on goal 16. Chute 140 allows the game piece to return into play if it enters the goal through any of the target apertures.

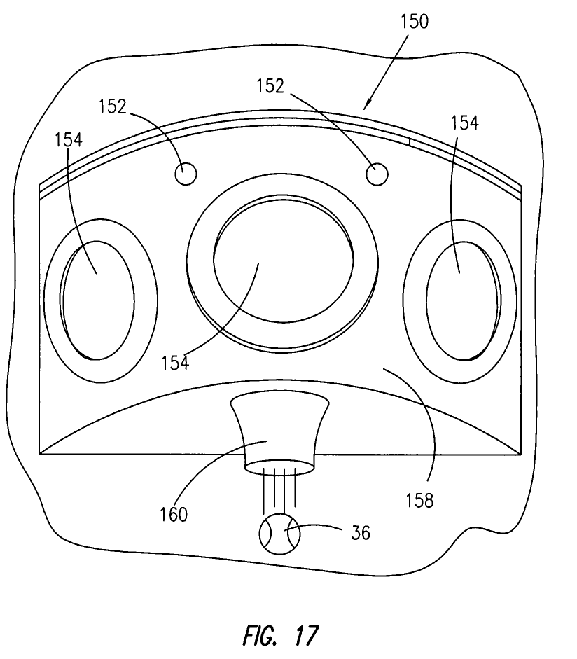

FIG. 17 is another embodiment for the goal in game 10. In this embodiment, goal 150 has curved face 158 with three target apertures 154. Light indicators 152 are located on the face of goal 150 and are constructed and used the same as light indicator 90 on goal 16. Similar to other embodiments, chute 160 is located at the bottom of the goal and operatively arranged to return the ball back into play.

It should be appreciated that the target apertures do not have to be the same size, the same shape, centrally located on their respective goal faces, or limited to one aperture per face. To increase game play strategy and difficulty, different apertures may be different shapes or sizes, as such modifications are within the spirit and scope of the present invention.

Although not shown, the vehicles may have display panels which communicate with the control terminal to obtain, then display various game aspects such as the time remaining, the score, or how many shots or penalties the player riding that particular vehicle has accumulated during the game. Also, the vehicles may have a set of speakers added, preferably near the top of the seats so they are proximate the player's head thereby allowing the referee to trigger a command to play pre-recorded messages to individual players.

### Operation and Game Play

A basic set of rules, strategies, and general operation of the preferred embodiment of the game will now be described to provide a better understanding of how the aspects of the game work together. Adverting back to FIGS. 1 and 2a, a depiction can be seen of game 10 in progress. The game is played between two teams and the object is to score more points than the opposing team. The game can be of varying lengths. For example, a game of thirty minutes could be separated into halves to give the players a short rest. Scoreboard 23 displays the time remaining and the scores of the two teams.

In this illustration the first team includes players 32a, 32b, 32c, and 32d, and the second team includes players 32w, 32x, 32y, and 32z. A player can score a point by shooting ball 36 through target aperture 38 in his respective goal. For example, the first team (players 32a-32d) is trying to score in goal 16a and the second team (players 32w-32z) is trying to score in goal 16b. FIGS. 1 and 2a illustrate player 32d taking a shot at target aperture 38 in goal 16a.

The vehicles driven by players in the first team preferably include an indicator which is a first color, and the vehicles driven by players in the second team preferably include an indicator which is a second color. This allows the players to easily distinguish which players are on which teams by looking at the color of the vehicle they are driving. In some embodiments the vehicles are actually painted a color or have their seats made from a colored fabric. In other embodiments the color of the car is determined by LEDs located about the vehicle so that each vehicle illuminates a color.

Although all of the first team is shown facing the same direction and all of the second team is shown facing the opposite direction, players are able to turn their vehicles in any direction and can go to any part of the play area. For safety reasons, players should not exit their vehicles while the game is being played. In preferred embodiments players must wear their seatbelts at all times, or they may be penalized.

In some embodiments, players carry scoop 34 in one hand and maneuver their vehicles with the other hand via a movement control device. The movement control device is preferably located centrally between the left and right sides of the vehicle. If it is centrally located then a player can use either his left or right hand to operate the vehicle. This is preferred as it accommodates people with left or right hand dominance, and it also allows a player the option to quickly switch hands while driving, which may advantageously free up their other hand for more effectively or strategically playing the game.

Wall bumper 20 is also connected to skirt 18 which is shown cross-sectionally in FIG. 2b. The wall skirt is sloped at angle 48 below the horizontal so that balls can not get stuck up against the wall. Instead, as shown in FIG. 2d, any ball that otherwise would have landed at the edge between the floor and the walls will instead roll down wall skirt 18 over wall bumper 20 and back into the play area for easy retrieval by a player. Additionally, the wall bumper and skirt together provide a buffer between the players and the walls, so that a player cannot hit his head or some other body part against the hard wall.

FIG. 3 shows the movement control device sitting atop movement control support 58, which allows the movement control device to be at an appropriate level for a player seated in seat 52. In these Figures the movement control device is joystick 62. Players grip joystick 62 and press it forward to move the cart forward, to the right to turn the vehicle to the right, to the left to turn the vehicle to the left, and towards them to reverse the vehicle.

The movement control device is preferably variable in rate of movement and rate of turning. Joystick 62 is preferably programmed so that when the joystick is slightly pushed in a direction the motors operate slowly, and when the joystick is pressed all the way in a direction the motors operate at their highest allowable speed. This allows the players the greatest degree of maneuverability when playing game 10. In a penalty mode, the referee can impose a penalty on one or more players, restricting the allowed speed of their car. For example, the referee can send a command which restricts voltage applied to the joystick to half-voltage, thereby restricting car speed to half-speed.

Shroud 60 is preferably included to protect joystick 62 from being pressed too hard in any direction, which may damage the joystick. Of particular concern is when vehicles are about to make head-on contact with another vehicle or wall bumper, players instinctively brace themselves for impact. This generally involves a player exerting an excessive force on the joystick when the joystick is in a full forward position, which may cause the joystick to bend or snap. As seen in FIG. 6, players are only able to grip joystick 62 with the tips of their fingers 68, and the bulk of their hands 66 must remain outside the shroud. If a player was allowed to fully grip the joystick, that player may intentionally or unintentionally damage the joystick. Therefore, shroud 60 advantageously protects the joystick from being damaged, which potentially saves on the cost of maintenance and replacement parts.

Wall bumper 20 is also connected to skirt 18 which is shown cross-sectionally in FIG. 2b. The wall skirt is sloped at angle 48 below the horizontal so that balls can not get stuck up against the wall. Instead, as shown in FIG. 2d, any ball that otherwise would have landed at the edge between the floor and the wall will instead roll down wall skirt 18 over wall bumper 20 and back into the play area for easy retrieval by a player. Additionally it provides a buffer between the players and the walls, so that a player cannot hit his head or some other body part against the hard wall.

The following is described in light of FIGS. 2b-3, and 8-10. The bumpers are preferably constructed so that they are firm enough to provide a solid impact, but are pliable enough to ensure the safety of the players. Also, in the event that a player's hand or other body part gets caught between two bumpers, it is ideal for the player to suffer no injury or as minor an injury as possible. As previously discussed, FIG. 10 illustrates a preferred configuration of the bumpers. It comprises a cushion made of high impact dense foam encased in a rubber membrane. This allows the bumpers to yield around a player's hand, leaving it virtually unharmed, should it happen to get caught between a vehicle bumper and another bumper. The rubber membrane is smooth so that it will not grip easily to skin, and therefore should not leave lacerations or brush bums if it roughly contacts a player. Also the rubber membrane allows the vehicles to easily slide off each other or the wall bumper during contact. Wall bumper 20 outlines the perimeter of the play area to eliminate any jarring contact with the hard walls. The wall bumper is constructed the same way and for the same advantages as the vehicle bumpers.

In a preferred embodiment, player moves joystick 62 which communicates with and activates motors 92L and 92R, seen in FIGS. 4, 5, and 13. The output from the motors is taken by drive regulators 98L and 98R to rotate wheels 96L and 96R, respectively. To turn left, motor 92R has a higher forward output than motor 92L, which causes wheel 96R to travel faster, thereby turning the vehicle. To turn right, motor 92L has a higher forward output than motor 92R, which causes wheel 96L to travel faster, thereby turning the vehicle. For particularly sharp turns, such as when the joystick is in a full right or a full left position, the wheel on the inside of the turn may rotate in reverse so that the vehicle essentially rotates in place. To move forward, both motor 92L and 92R move at the same rate of speed so that the vehicle does not turn. To reverse, the motors both operate at substantially the same speed, but they do so in a reverse direction, causing the car to move backwards. Therefore, in this preferred embodiment, joystick 62, motors 92L and 92R, drive regulators 98L and 98R, rotate wheels 96L and 96R collectively comprise both a drive means and a turning means for vehicle 28. In other embodiments distinctly different systems could work independently to either move the vehicle or turn the vehicle. For example, both wheels could always rotate at the same speed, so that turning is achieved by a system such as a rack and pinion apparatus to physically change the orientation of the wheels with respect to the vehicle, instead of different rates of speed, as was just described above.

The goals have a plurality of multi-planar apertures to provide two main advantages. First, it allows players to take shots from the corners of the court, which spreads out the players on the court, and allows for more strategic and interesting game play. If the goal only had one target aperture, then the middle of the court would almost always be congested with players, because that would be the only location from which to score a goal. Secondly, it allows the game to be played on a much smaller play area, since the players will be spread out evenly throughout the play area, instead of congested in the middle. A smaller court significantly decreases the rental or real estate costs of operating a court to play game 10 by the same number of players as a larger court with only a forward facing target aperture.

Players use scoop 34 to pass the game piece to another player, or to retrieve the game piece if it is on the ground. In embodiments which use scoop 34, players are only allowed to interact with the ball by use of their scoop. Not all embodiments use scoop 34 and players instead throw the ball, or shoot it similarly to basketball. It is preferred in all embodiments that a soft, lightweight ball be used, so that players are not injured if they are hit by an errant shot or pass.

A player is also able to maneuver his vehicle into another player's vehicle to push that player away from the game piece, jar the game piece loose from that player's possession, or disrupt a shot or pass that player is trying to perform. In some variations of the game, bumping other players may be encouraged, while in other variations, penalties may be issued for particularly hard or repeated bumping.

The referee operates the game by touching (or clicking, in those embodiments without a touch-screen) the buttons displayed on the control terminal. The referee generally enters into the control terminal all important actions that occur by players during the course of a round of playing the game. Such important actions may include, but are not limited to passes, shots on goal, goals scored, rebounds, retrievals off the ground, and penalties. The referee also controls when the game clock starts, stops or pauses. The referee can edit the time on the game clock and can also edit the scores of each team on the scoreboard.

The control terminal preferably communicates with the vehicles, speakers, lighting, goals, vehicles, and other components of the game by a plurality of wireless transmitters and receivers placed throughout the play area. Since some components, such as the goals and speakers, are stationary and may be located near the walls, they may instead be hard wired to the control terminal. In a preferred embodiment, each vehicle has a transmission and receiving means located on it for communicating with the control terminal. Various methods of wireless communication which may be used in other embodiments include, but are not limited to infrared, wireless Ethernet, radio, or Bluetooth technologies.

### Circuit Operation

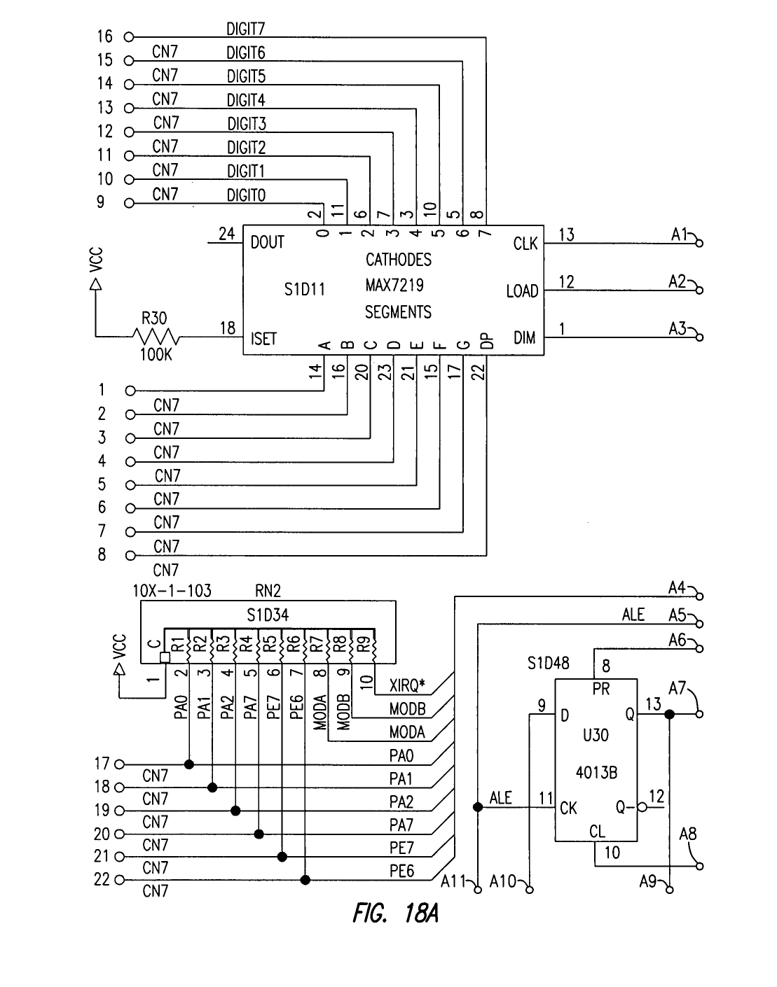

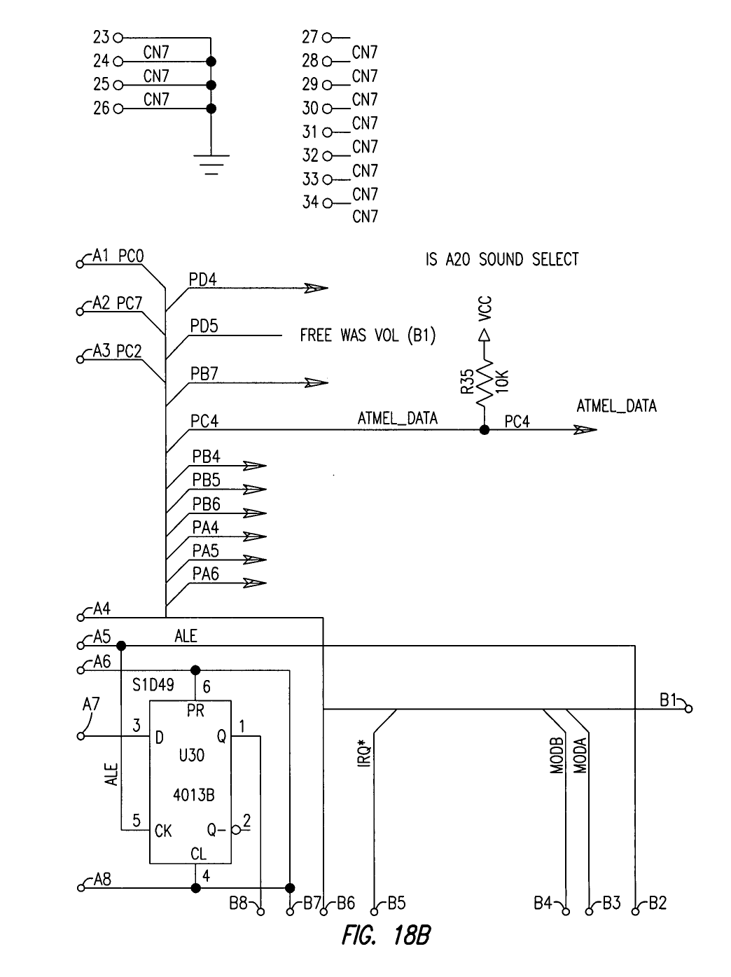

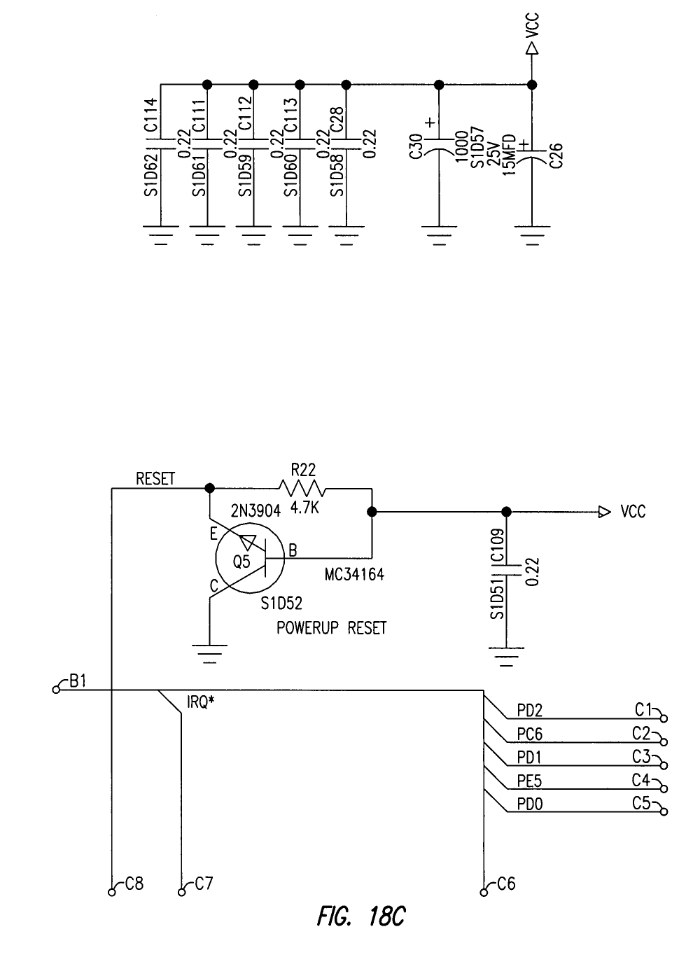

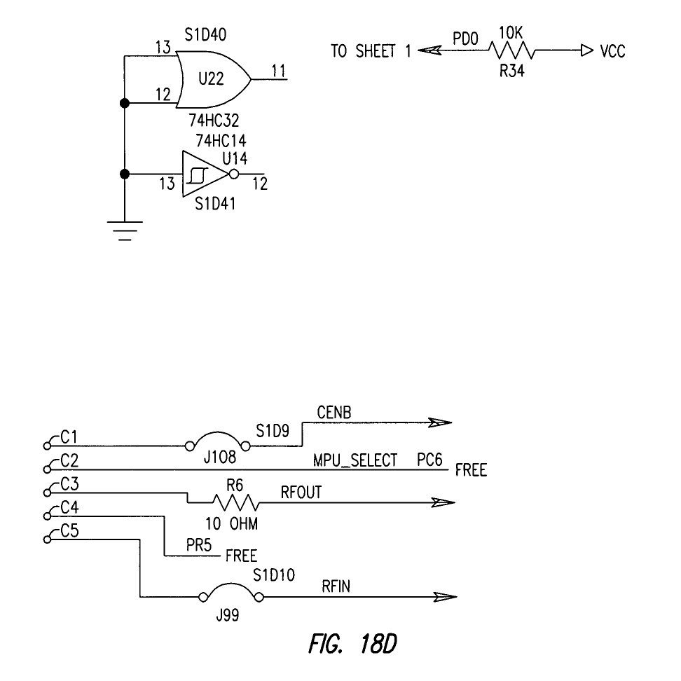

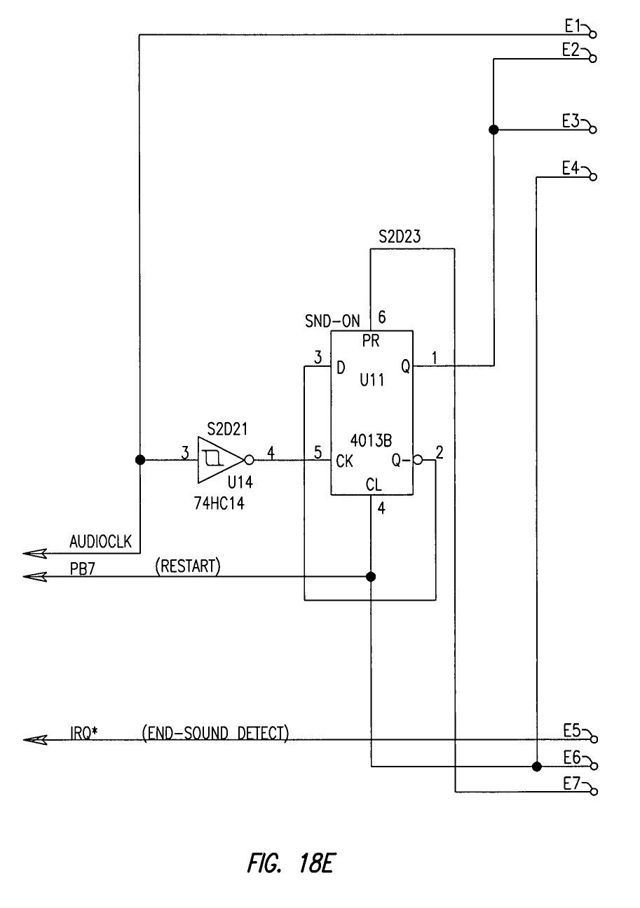

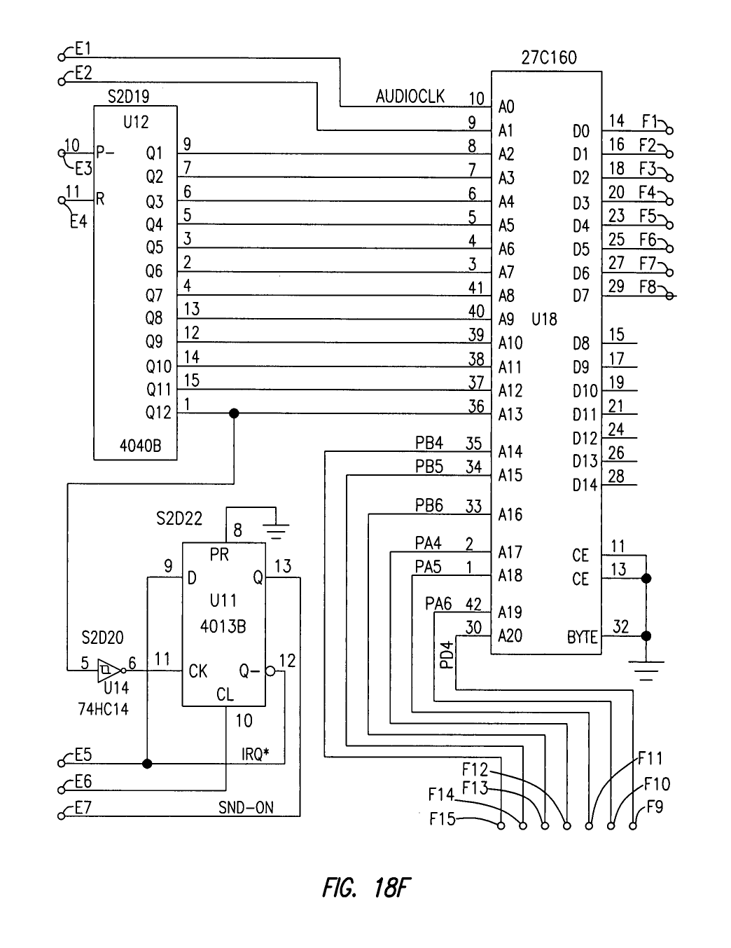

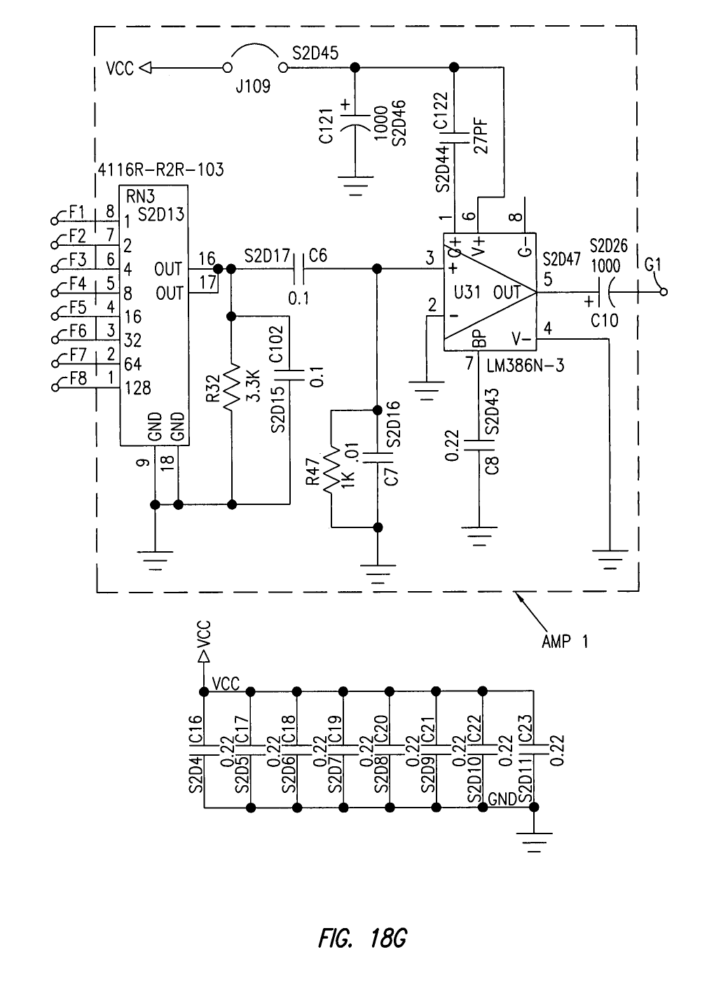

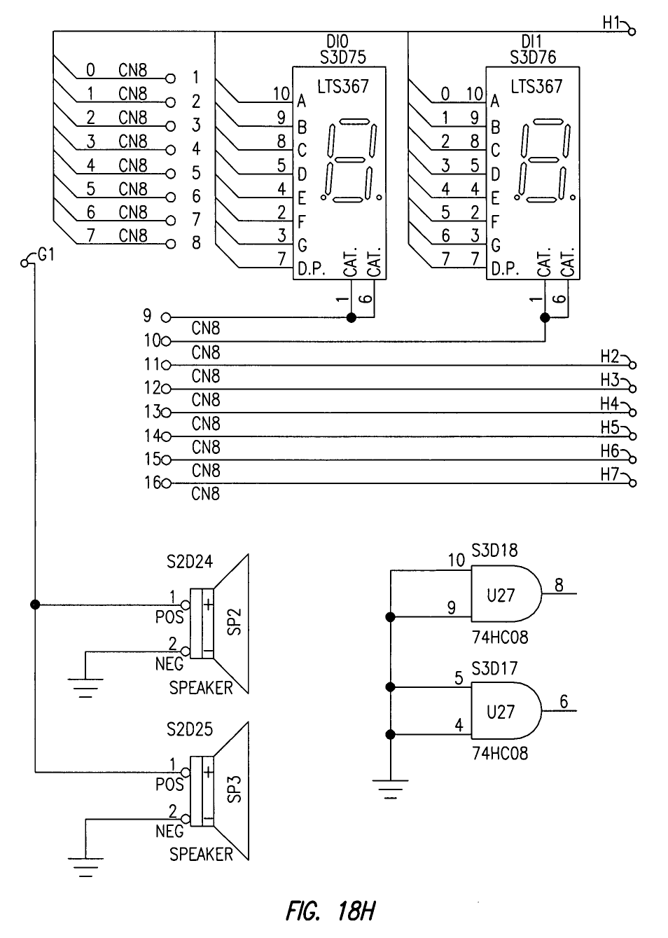

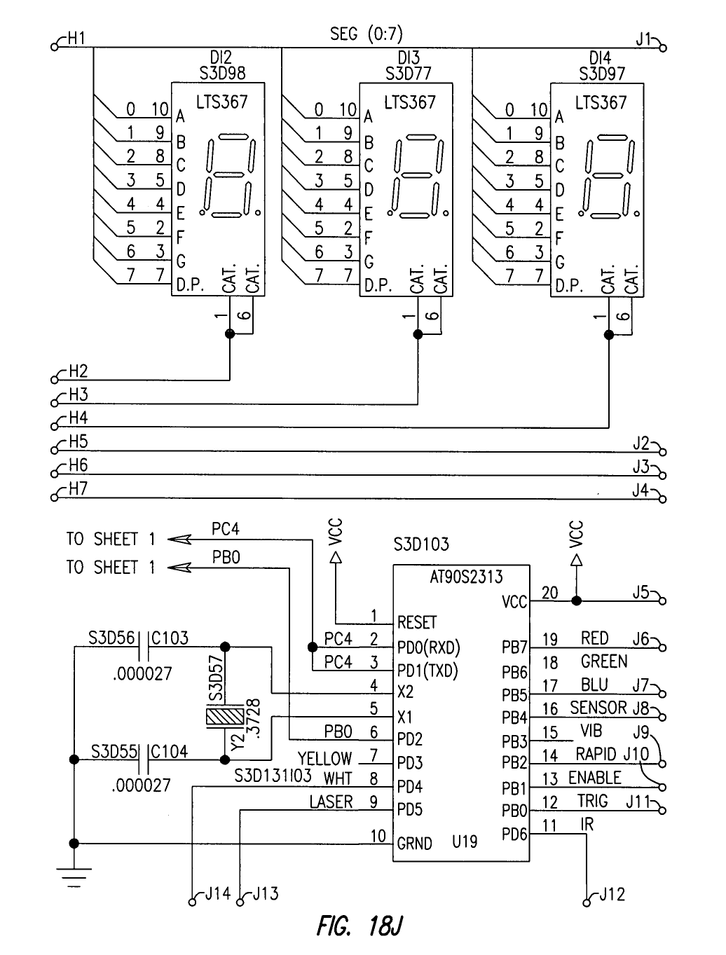

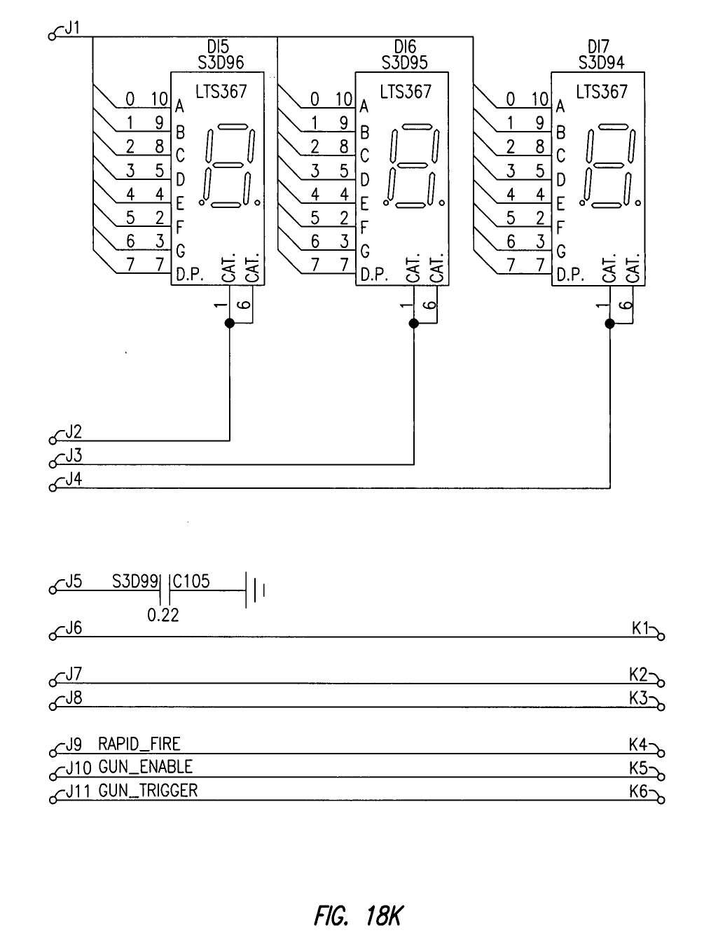

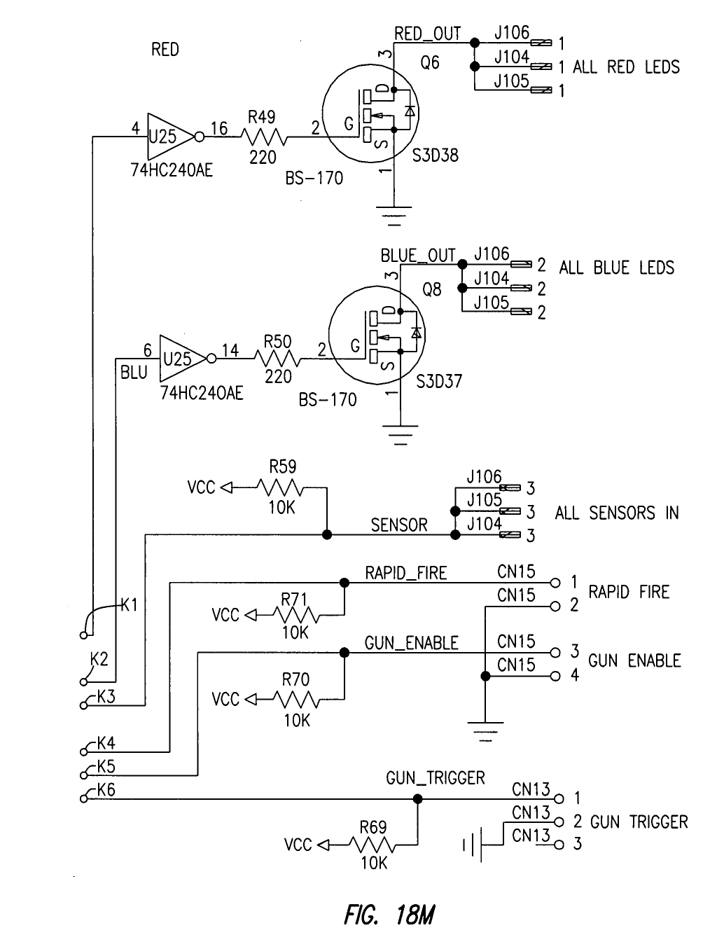

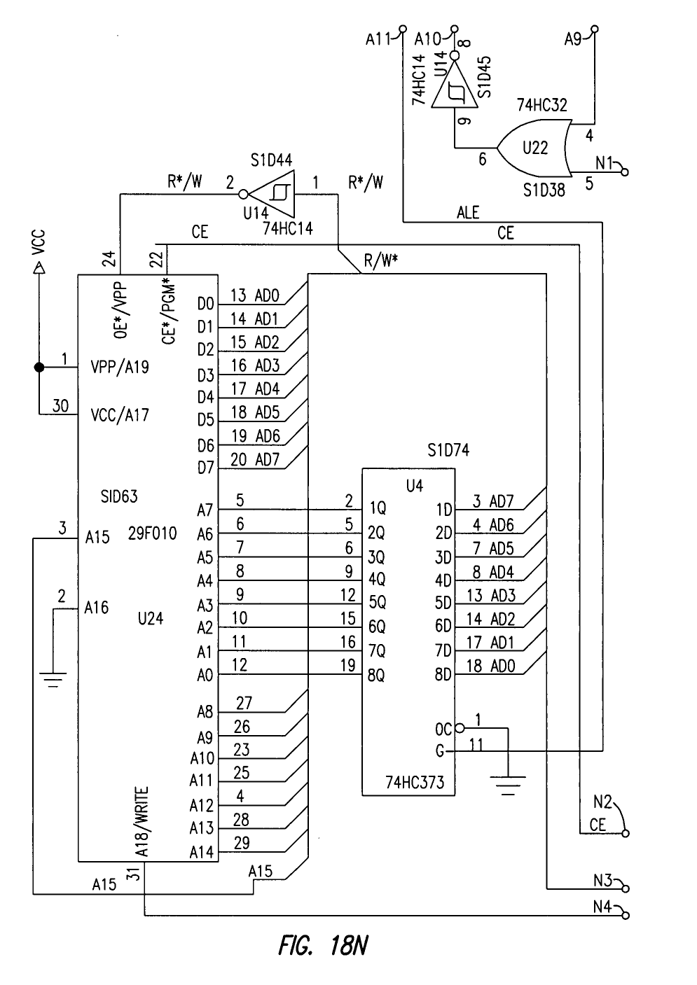

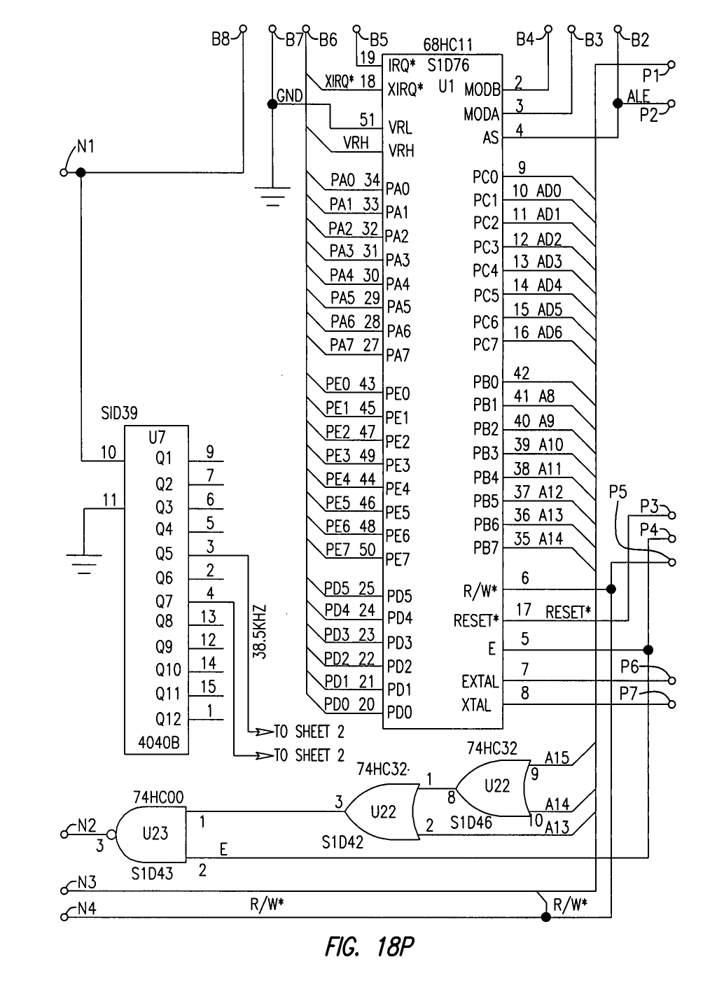

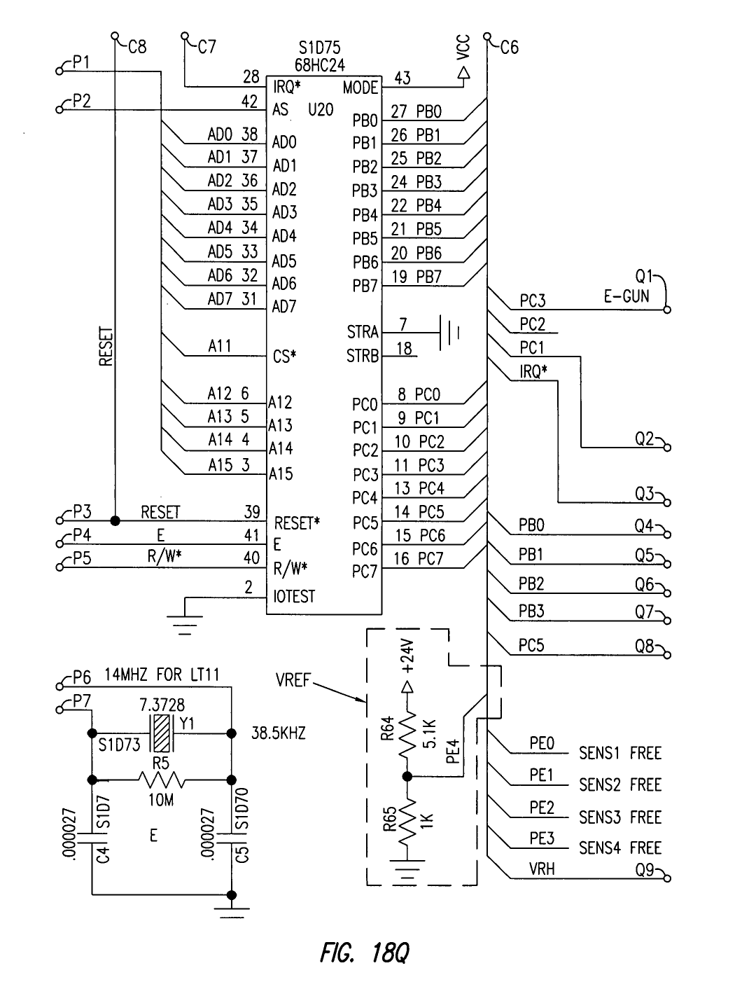

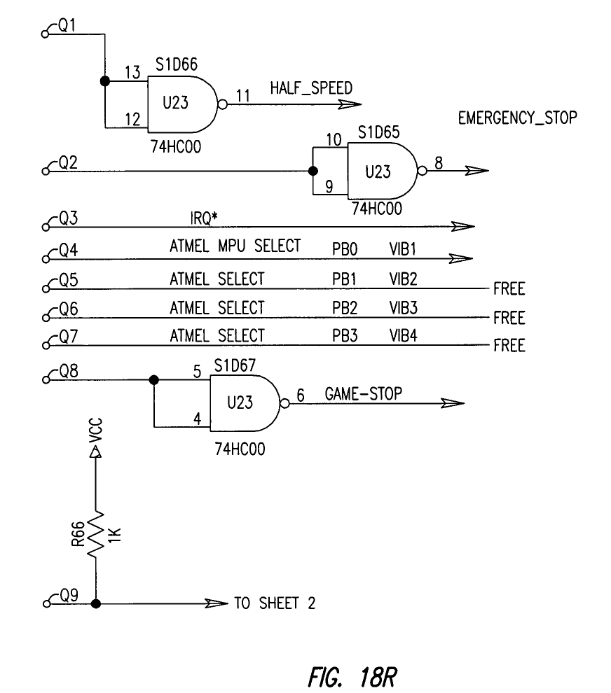

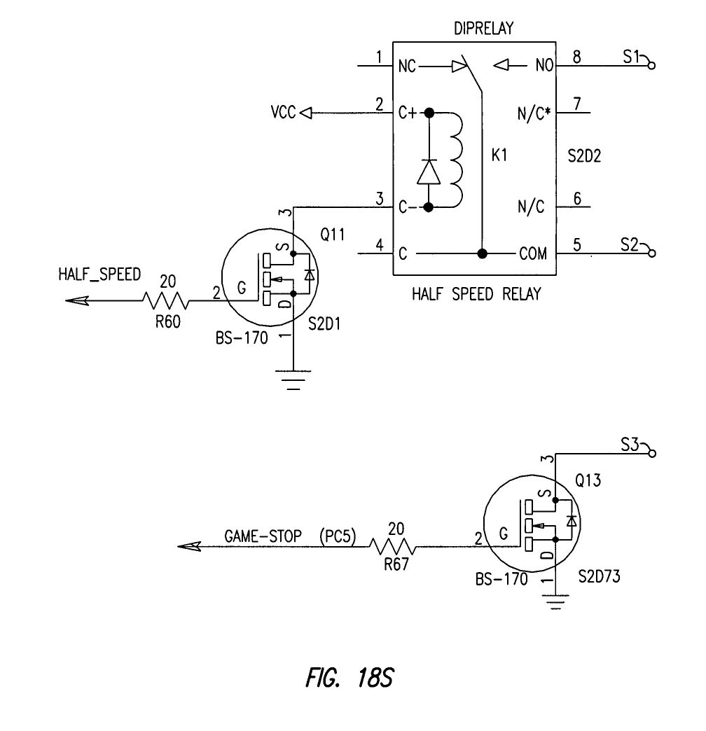

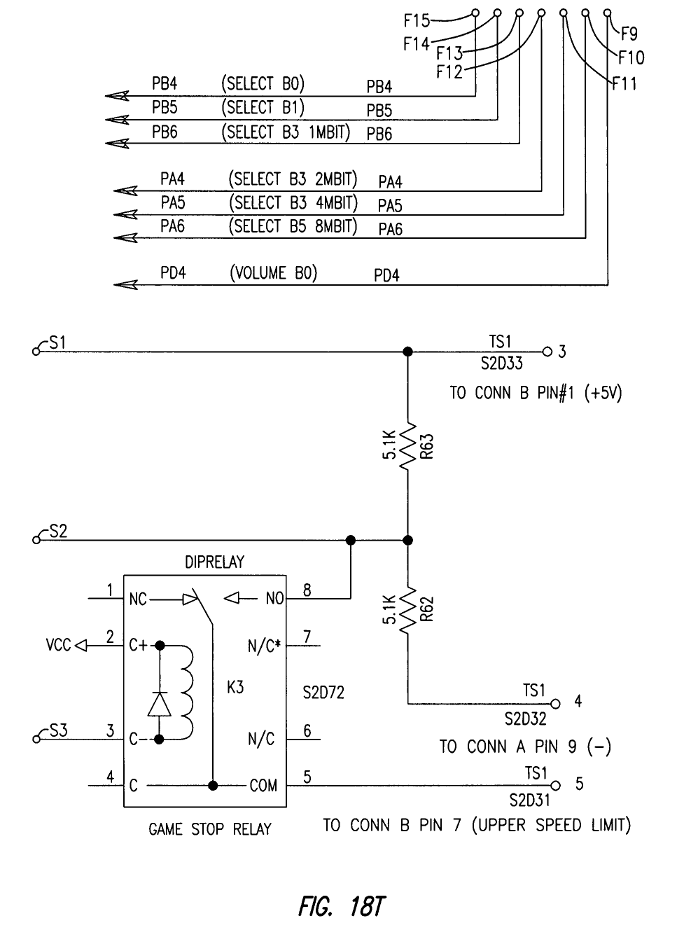

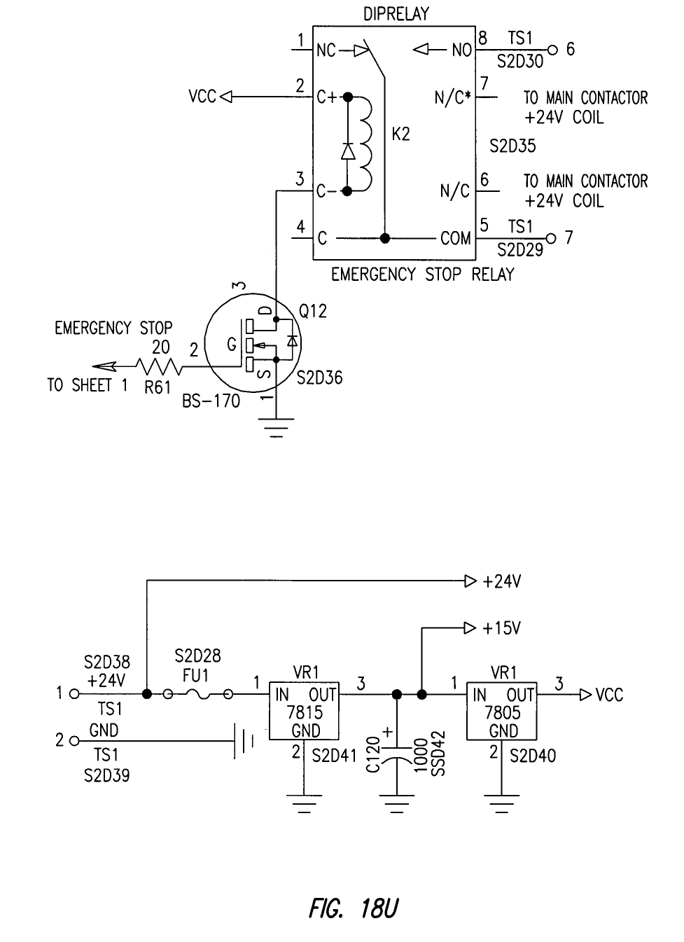

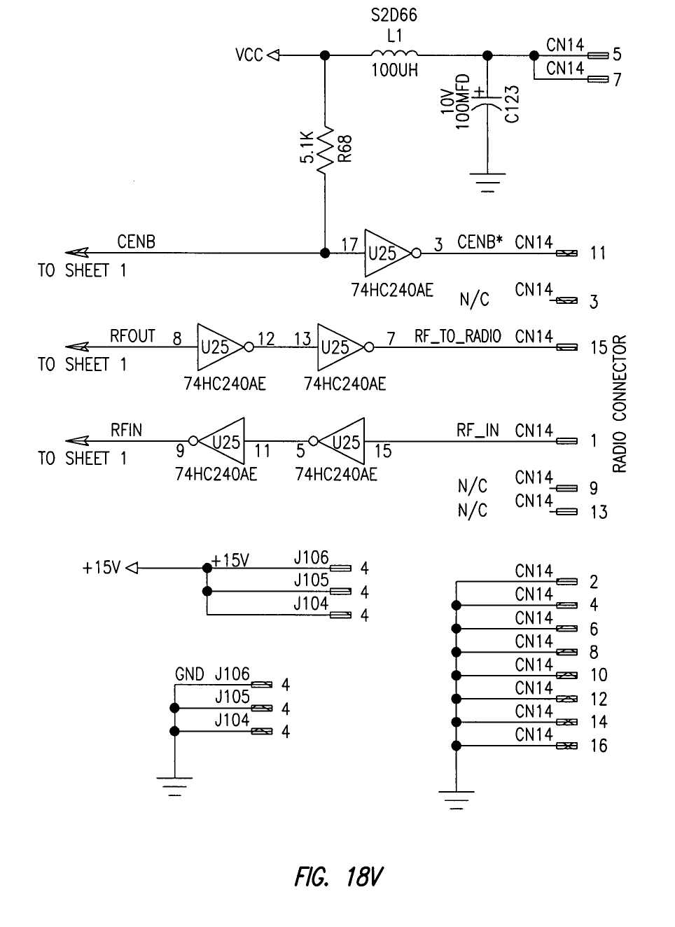

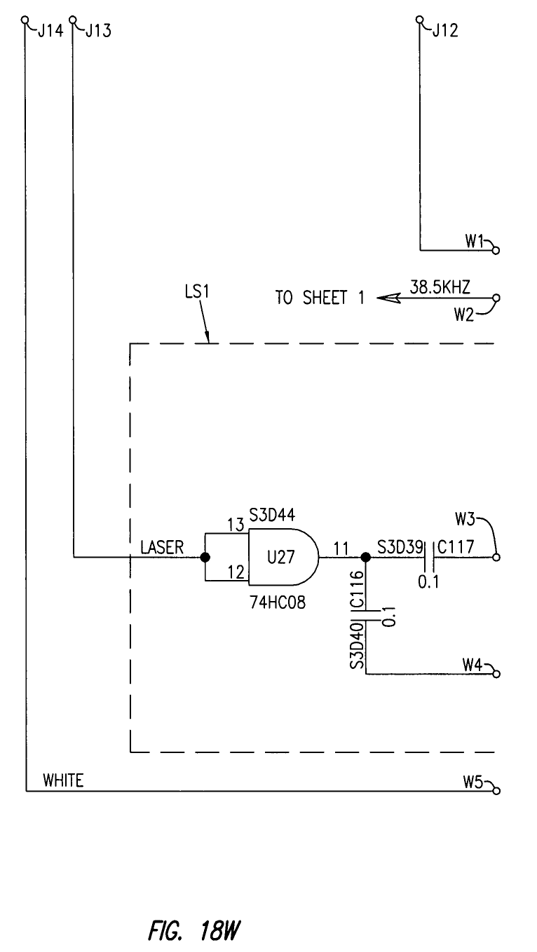

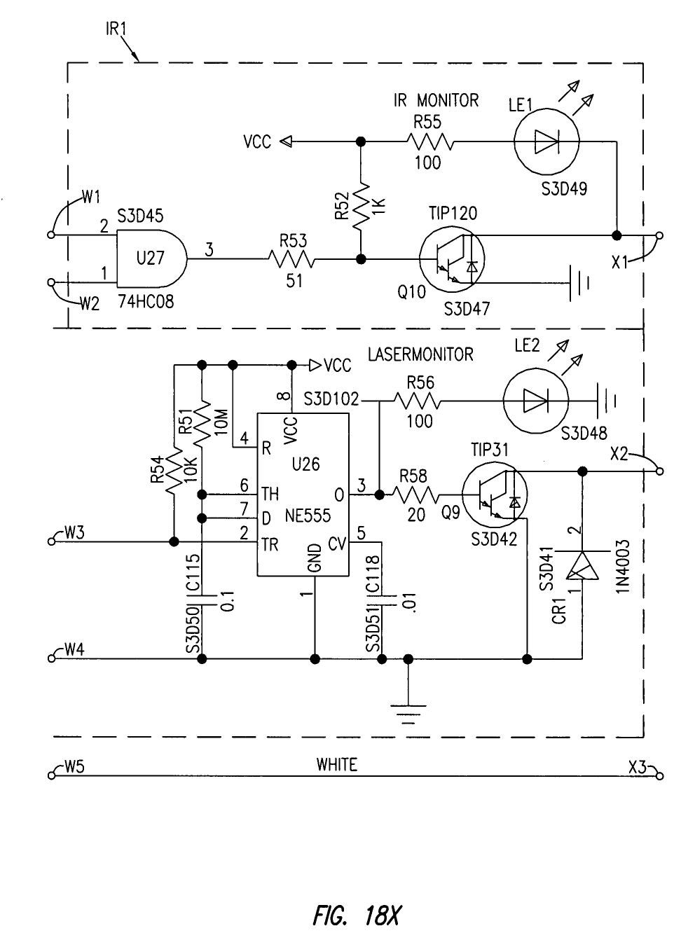

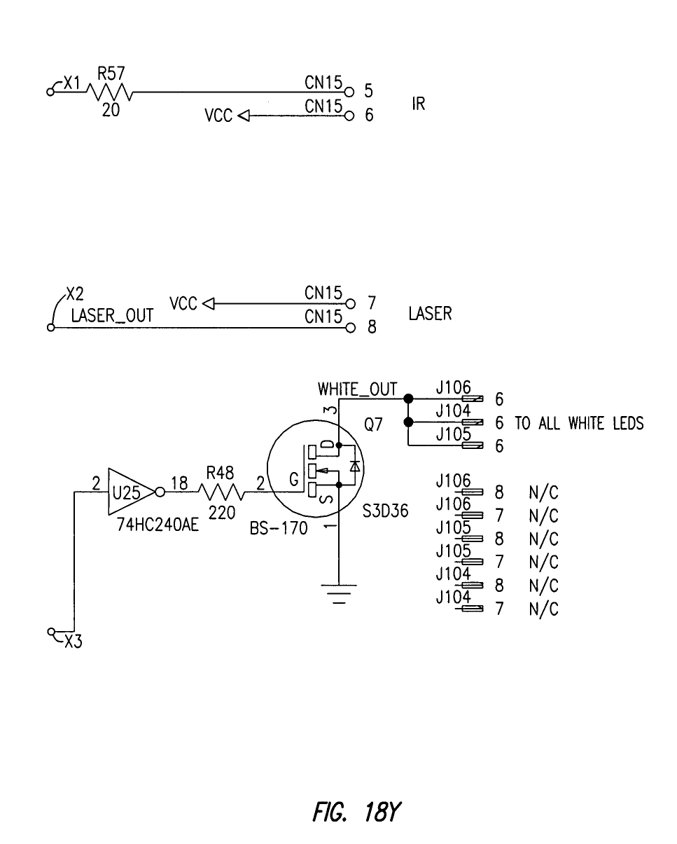

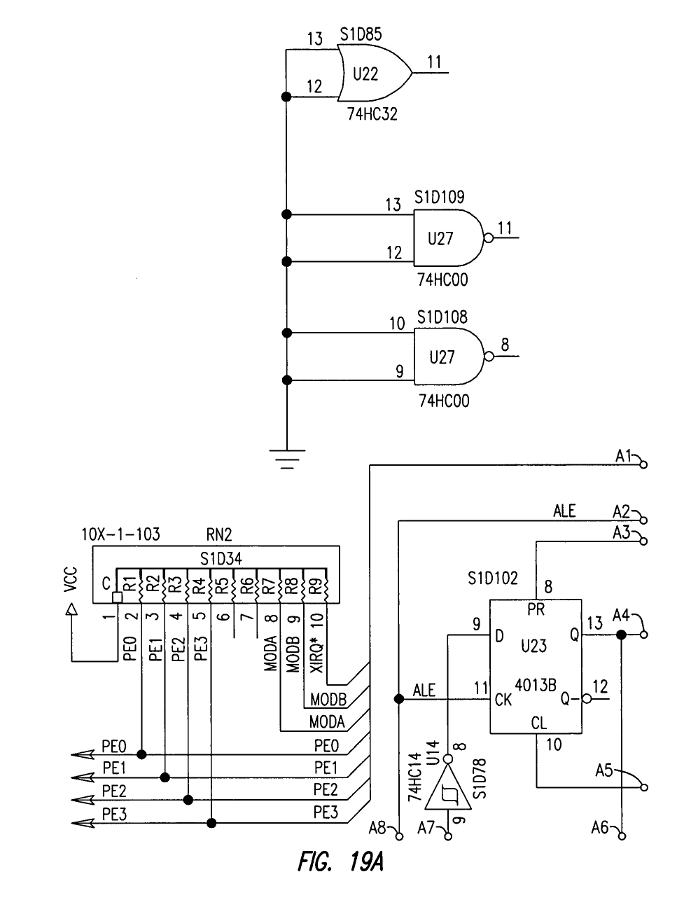

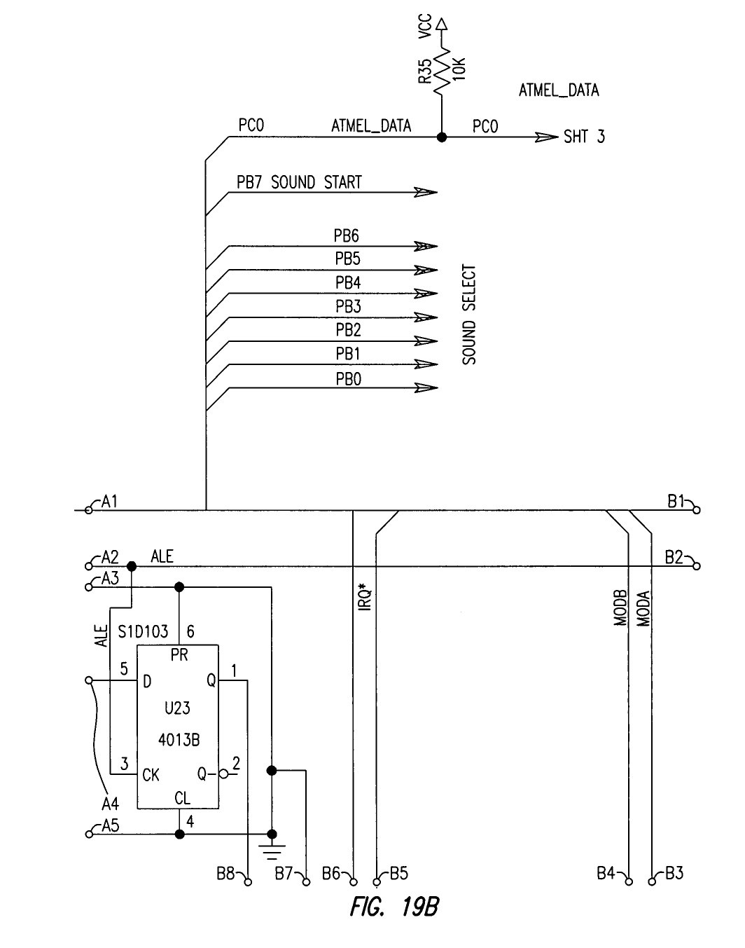

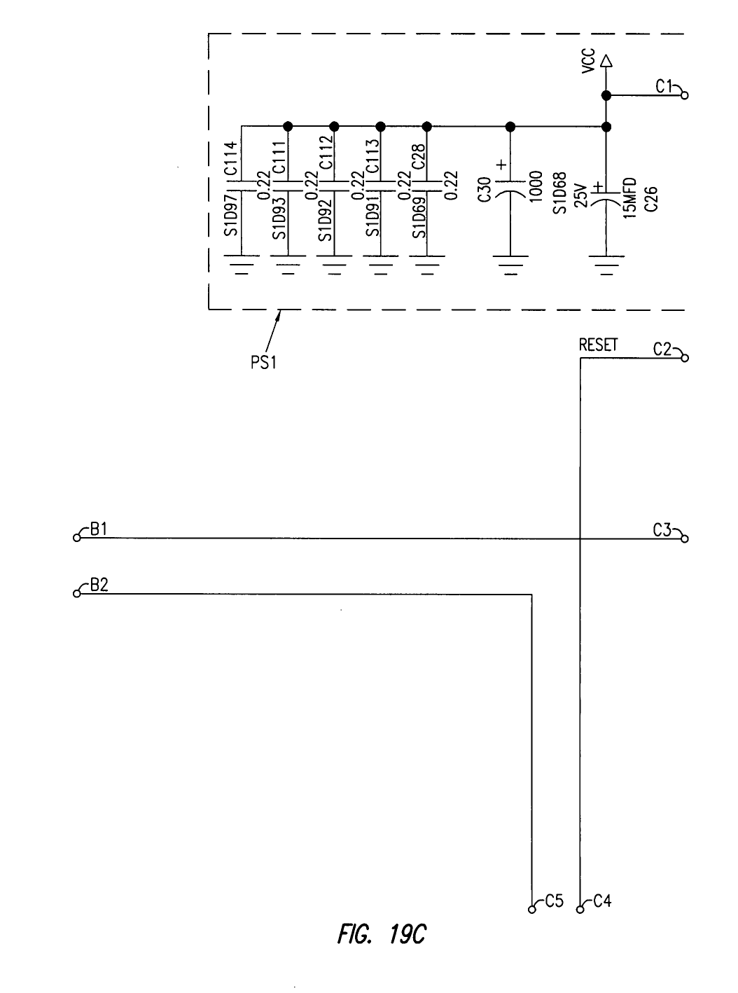

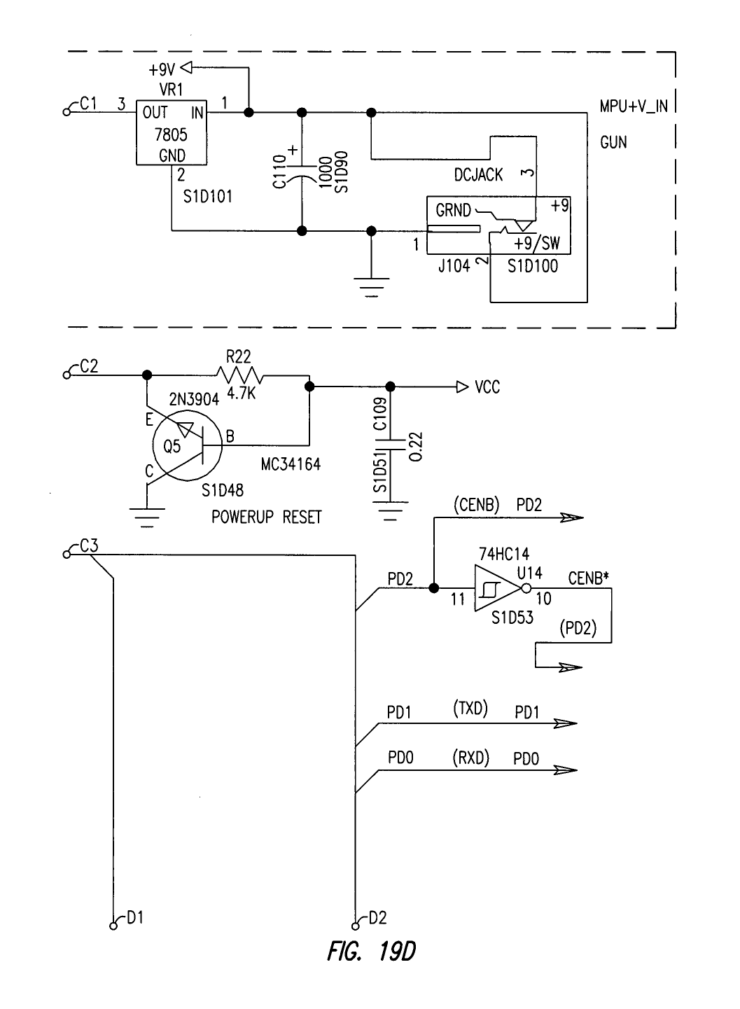

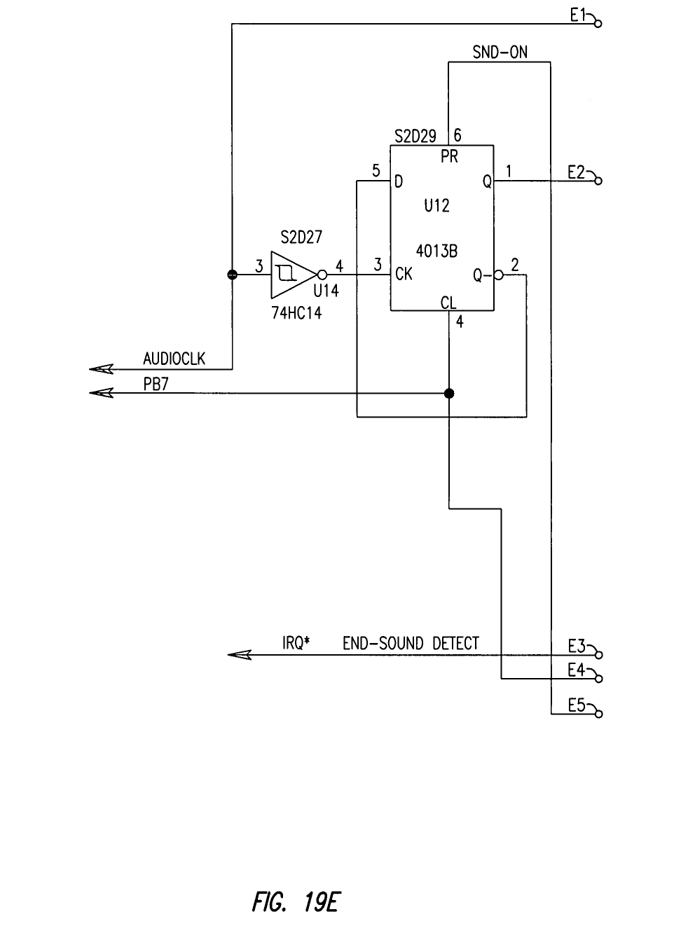

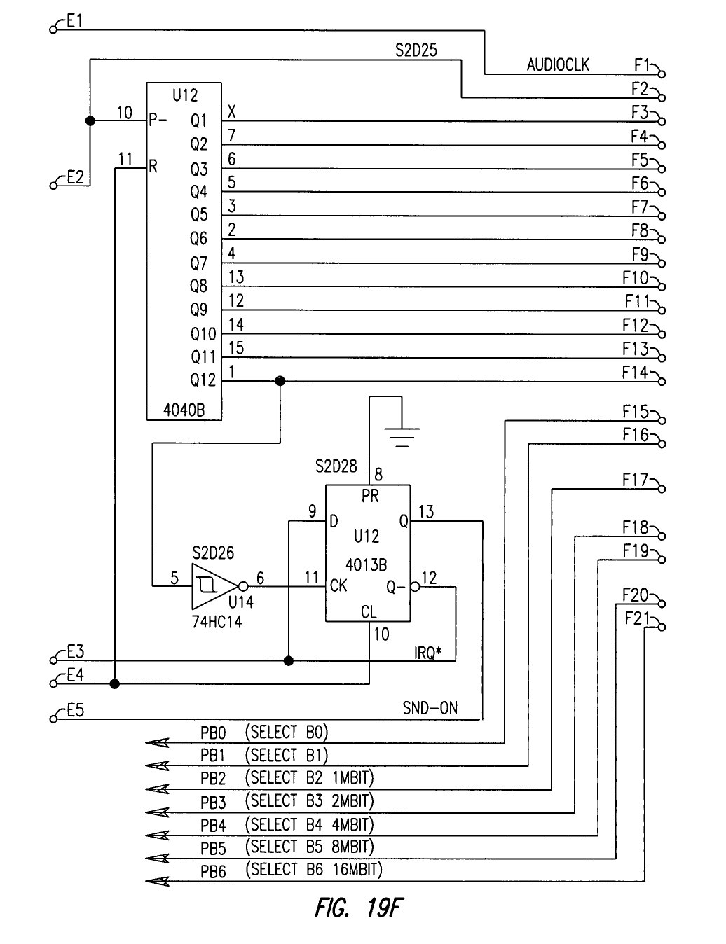

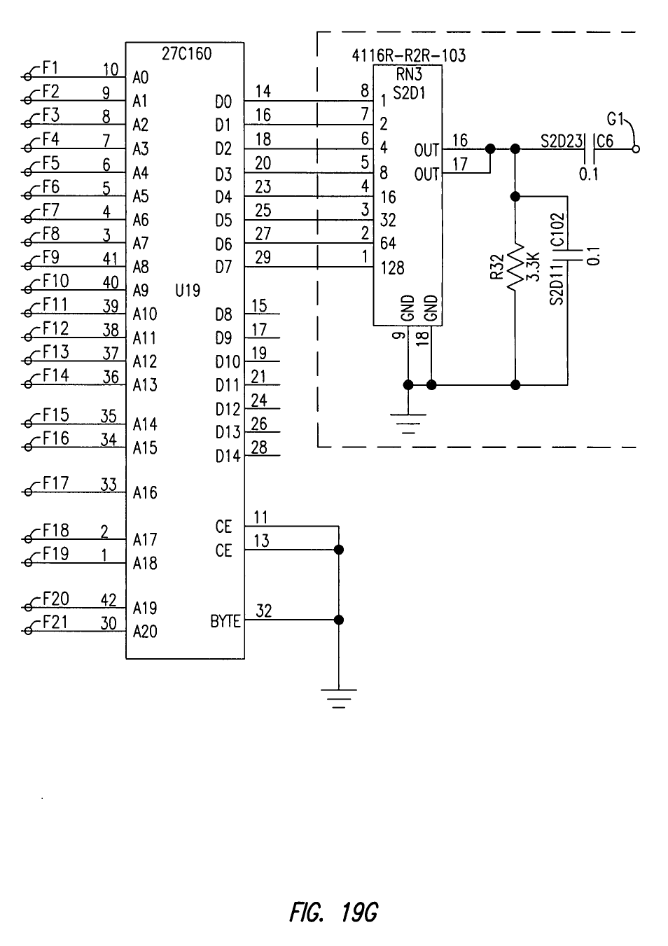

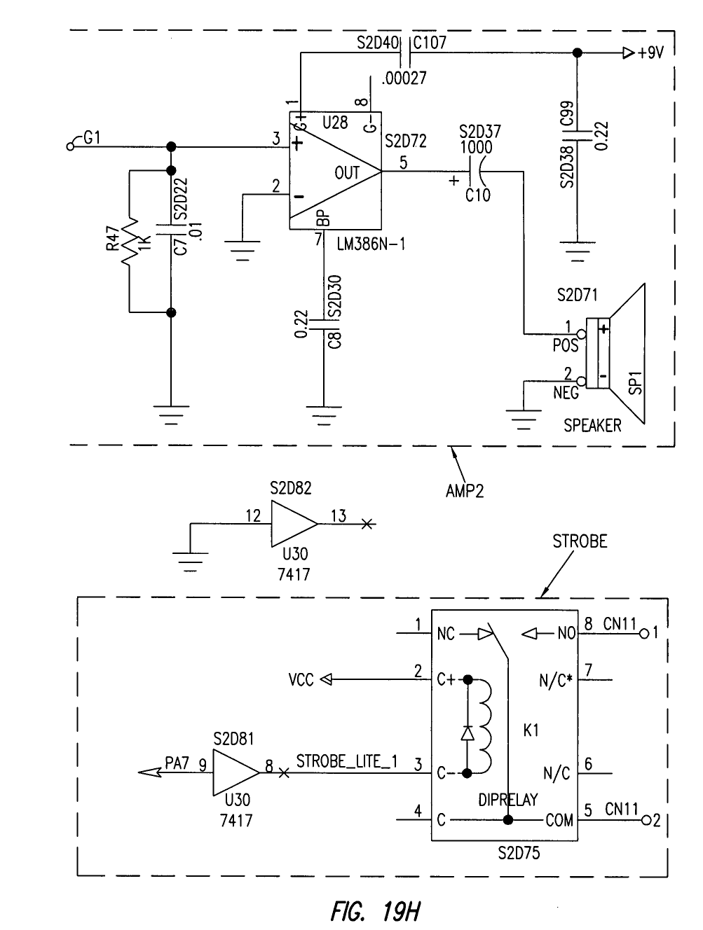

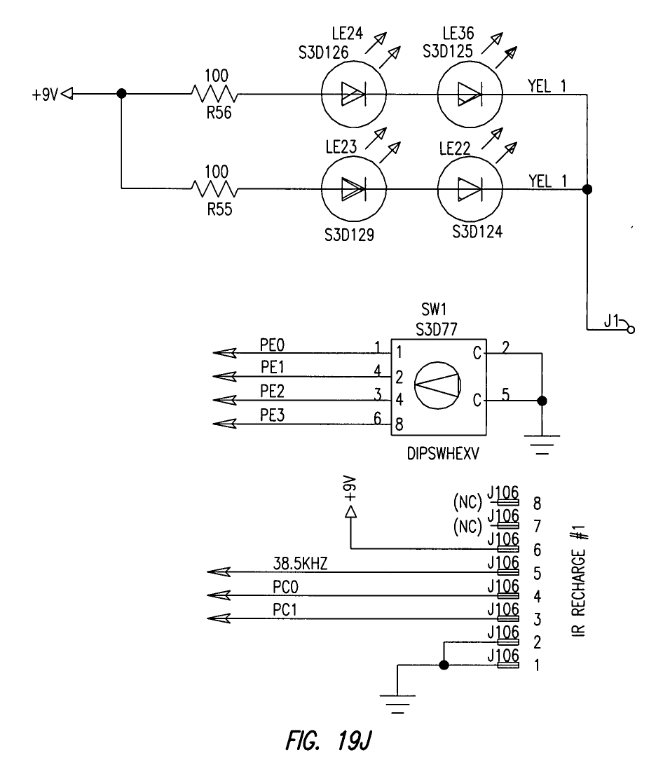

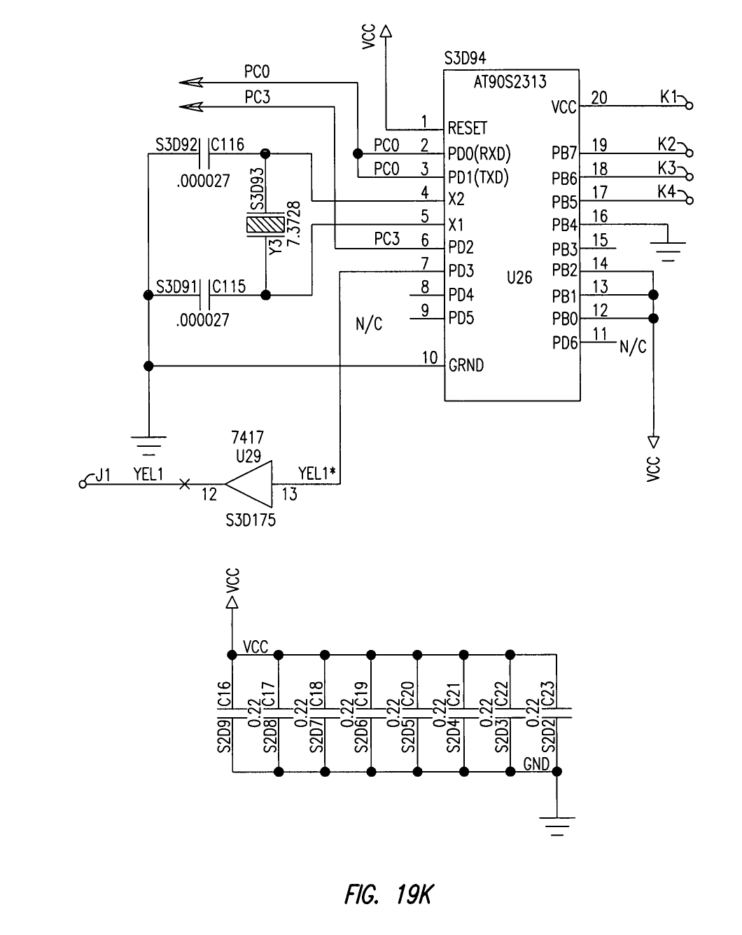

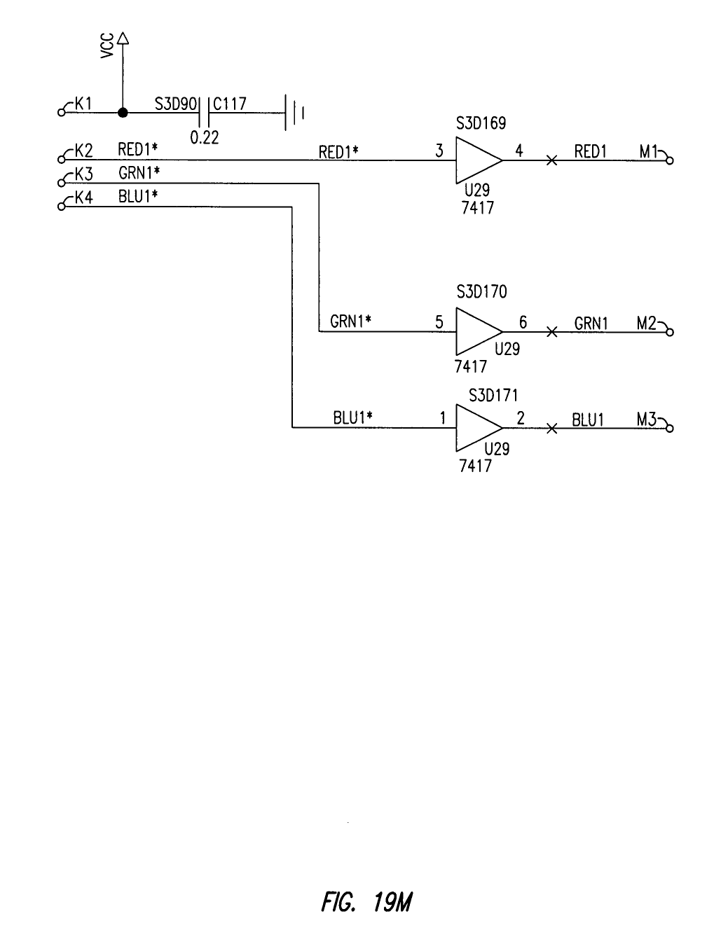

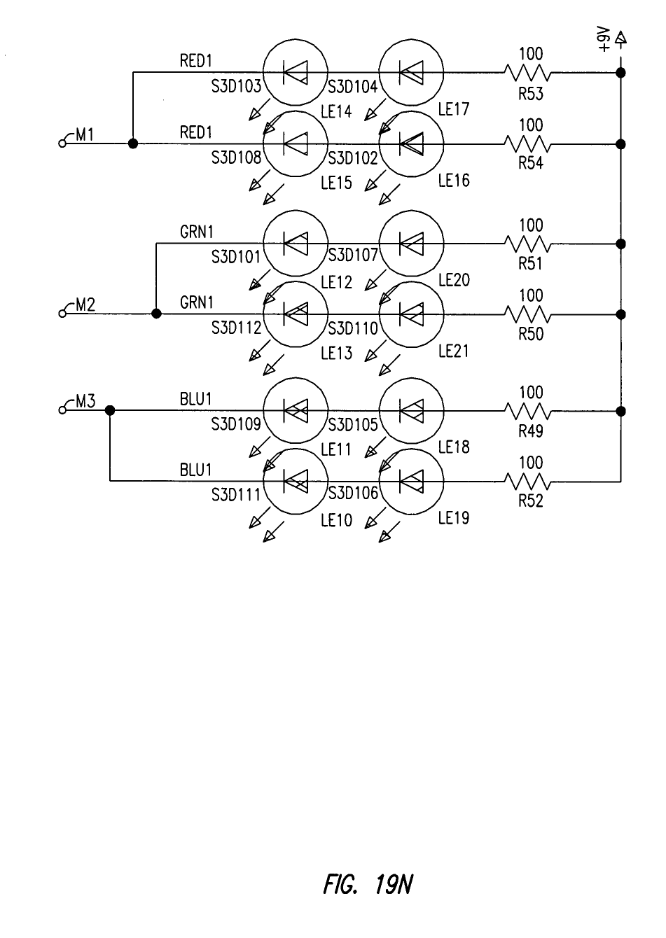

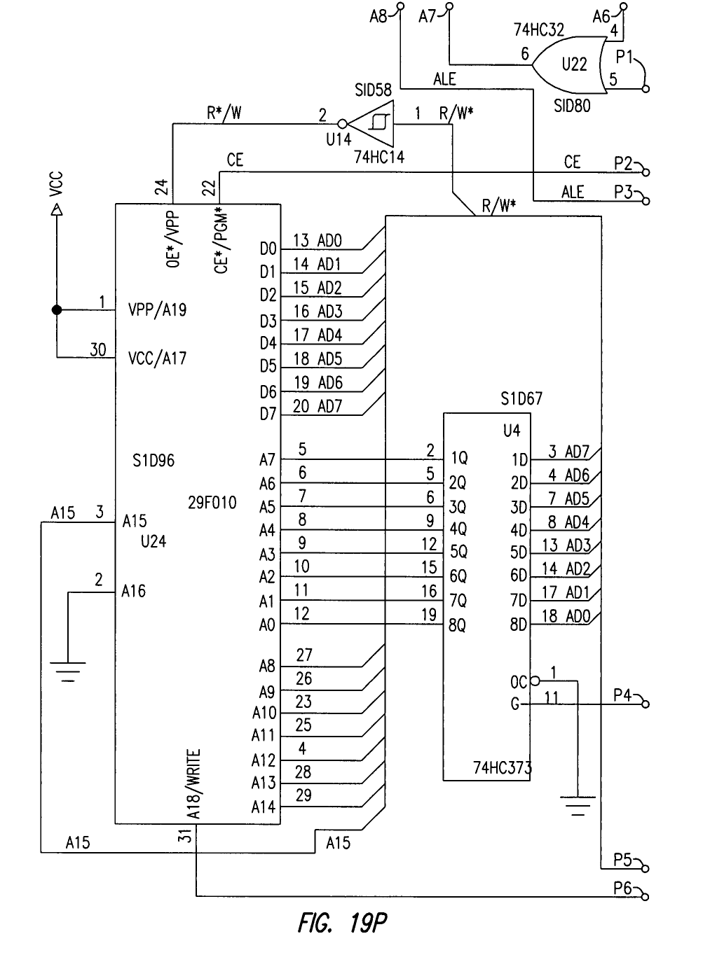

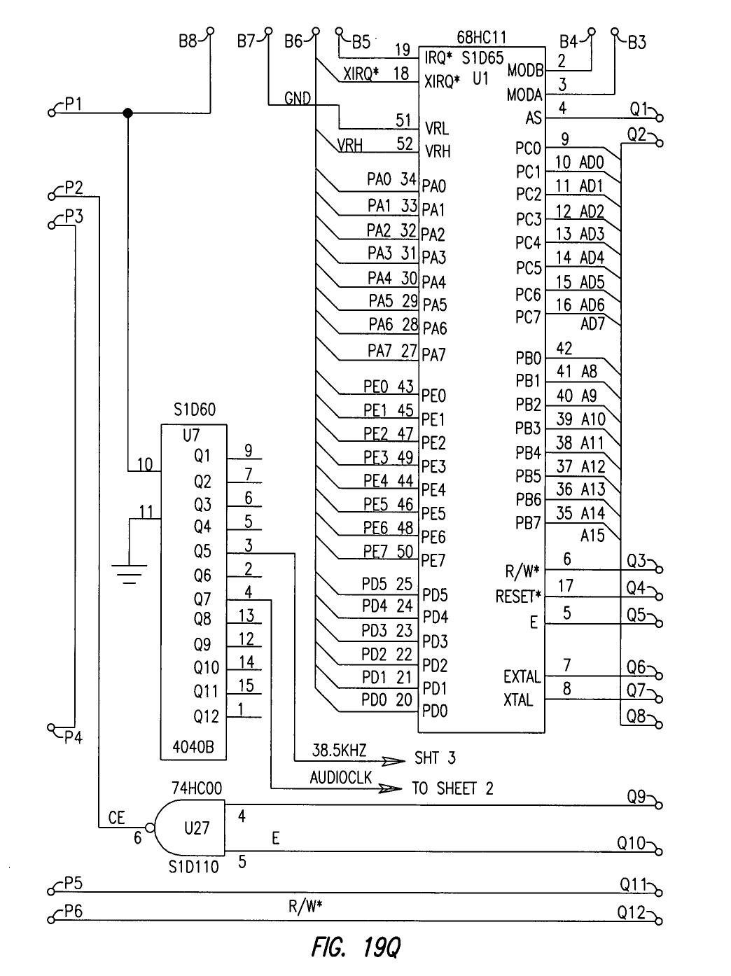

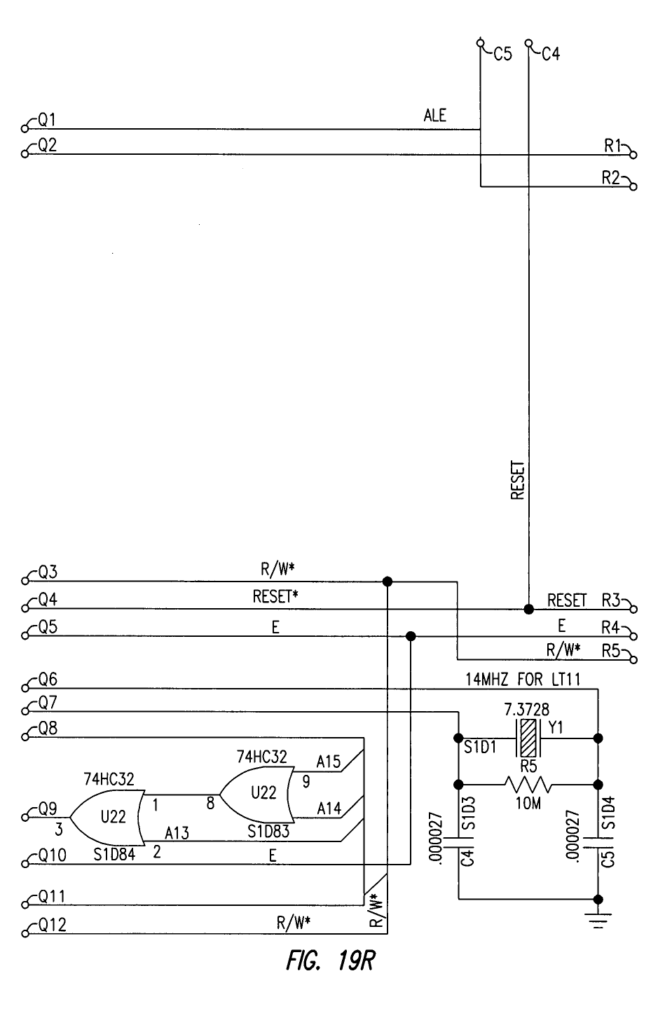

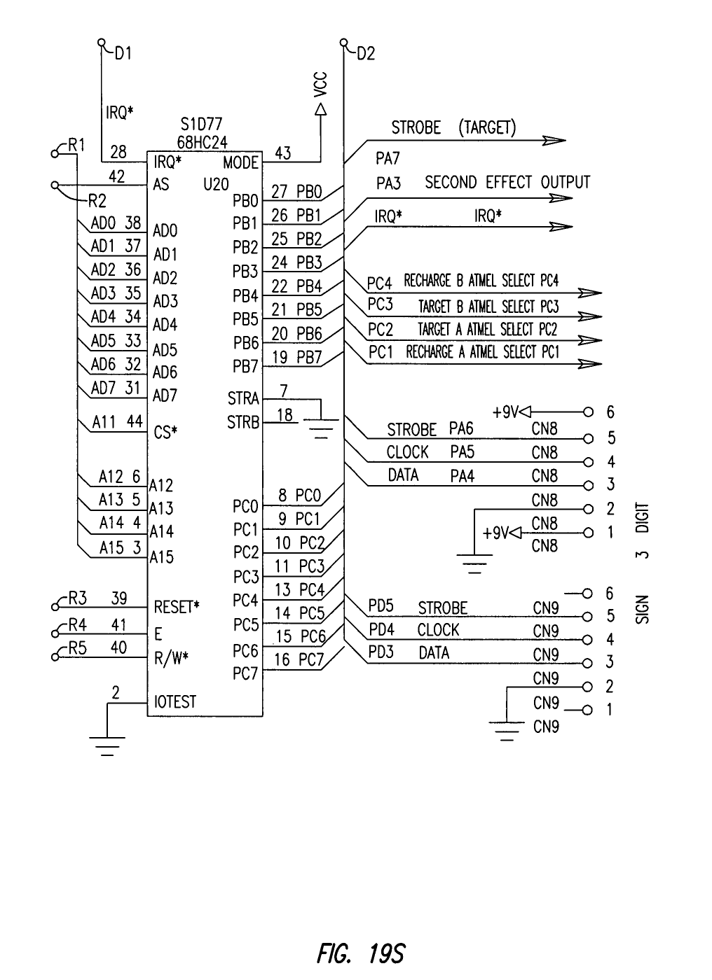

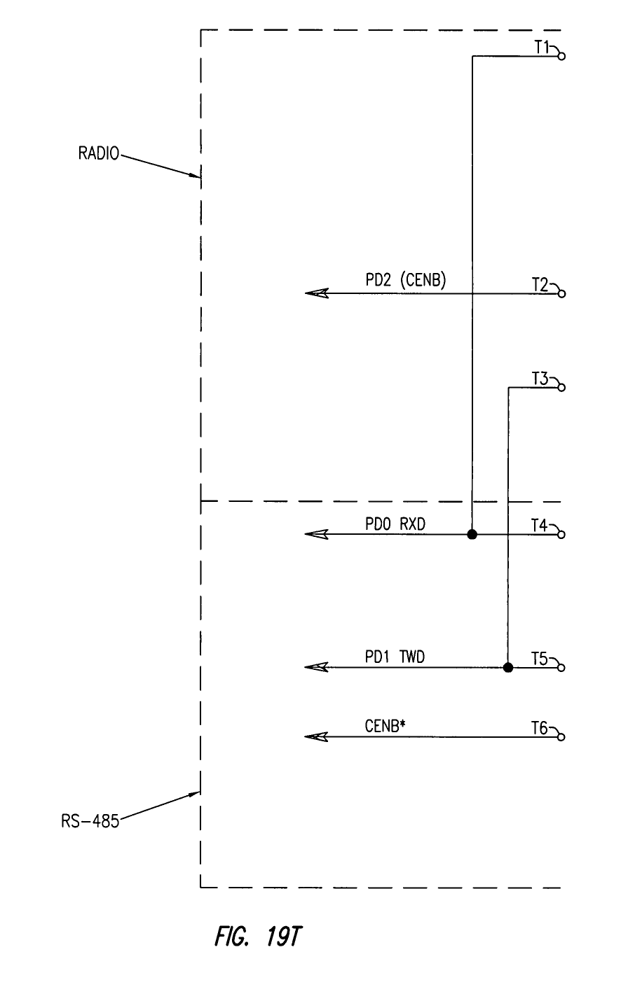

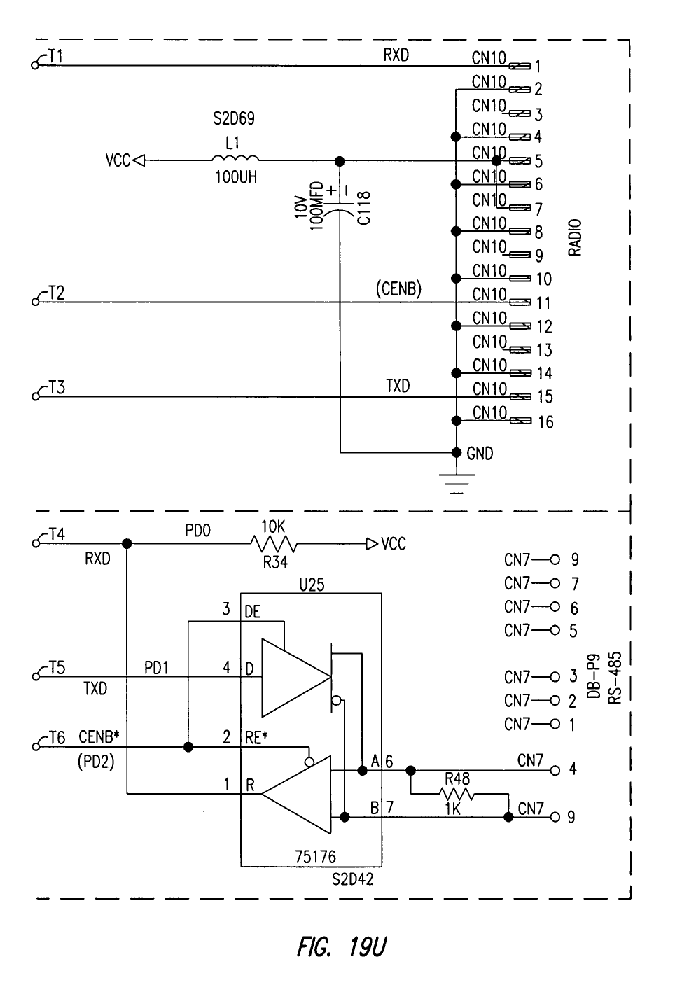

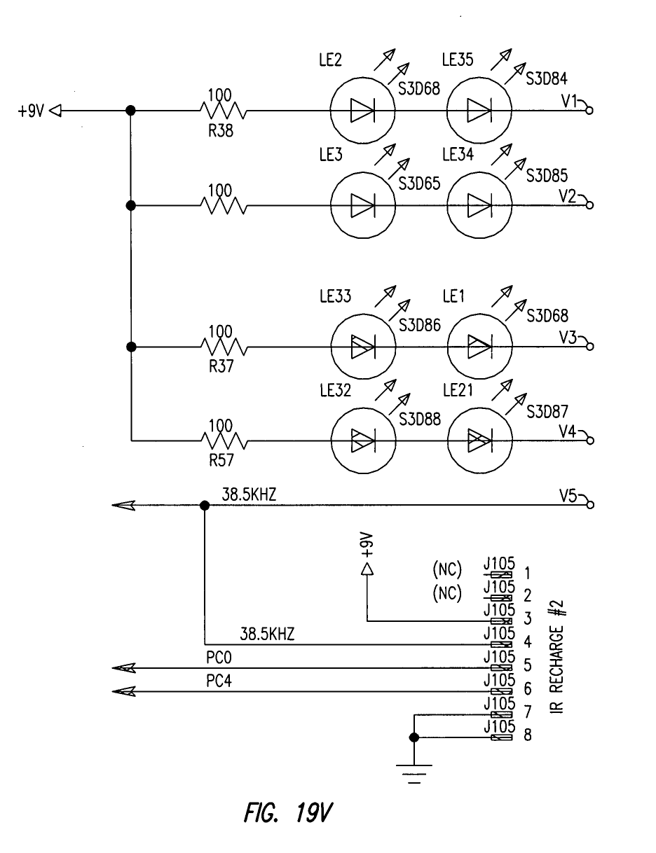

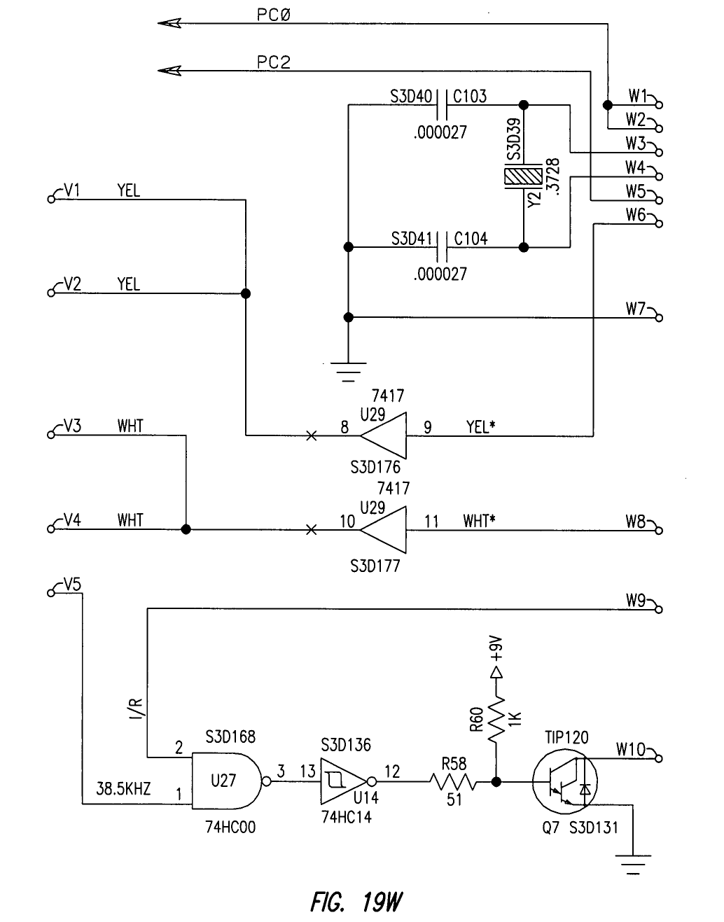

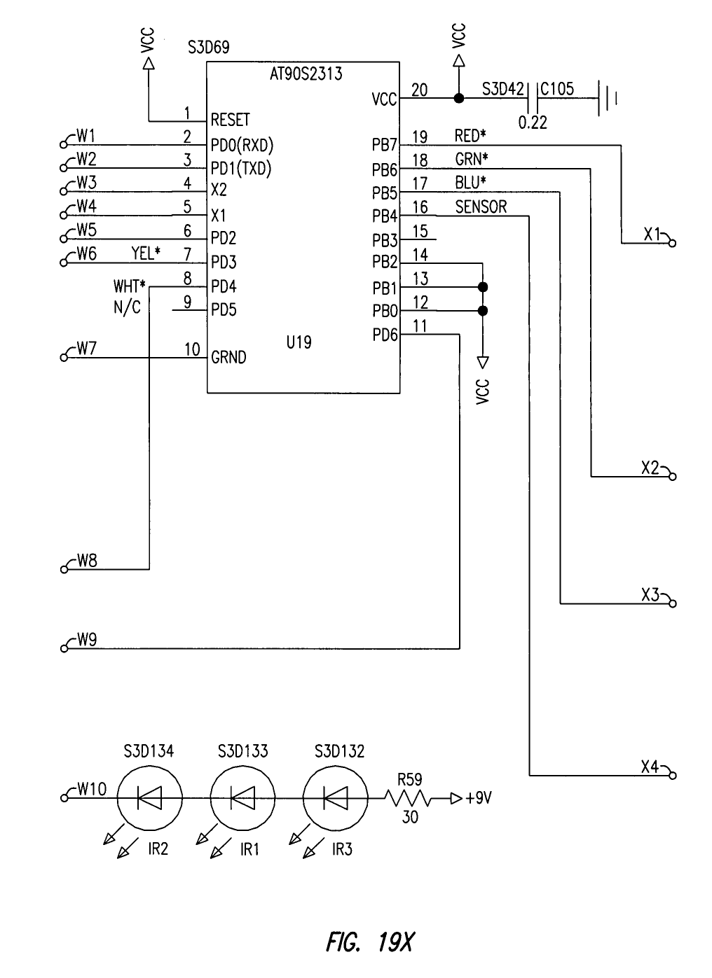

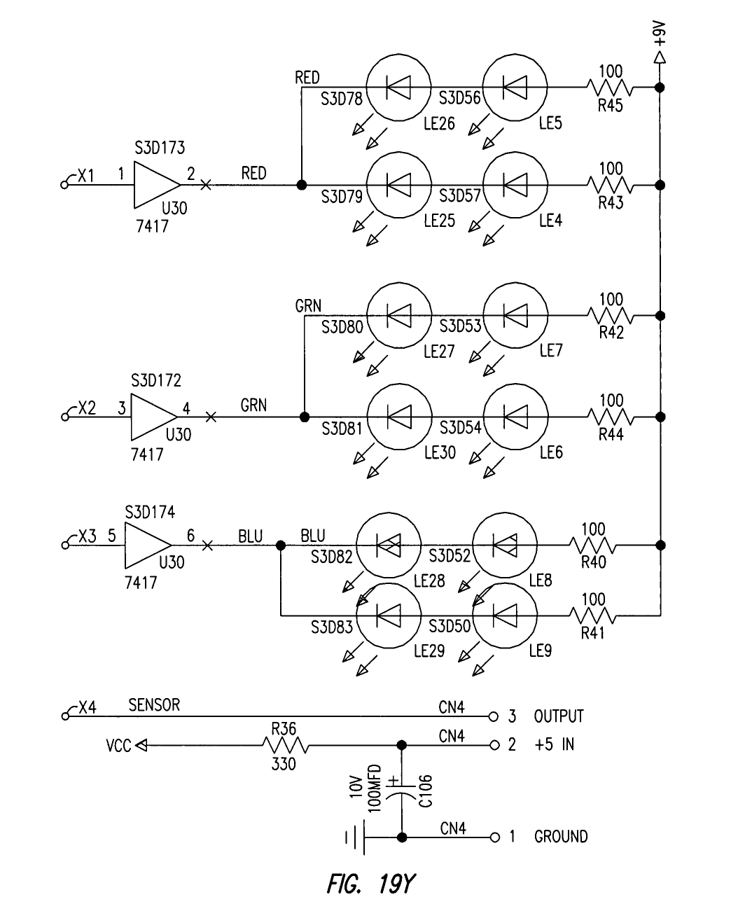

The control circuit for the game is shown in FIGS. 18A-19Y. It should be appreciated by those having ordinary skill in the art that variations and modifications in the circuit can be made without departing from the spirit and scope of the invention as claimed. The circuit is provided to illustrate a preferred embodiment of the invention, and the best mode of practicing the invention known to the inventors at the time of application for patent, and to enable those having ordinary skill in the art to make and use the invention. It should be appreciated, however, that there are different ways to implement the invention as claimed. For example, communications used in the game between the host and cars could be accomplished by infrared or RF communication without departing from the spirit and scope of the game as claimed.

FIGS. 18A-18Y illustrate the “car control circuit”, so named because the circuit board containing this circuit is located in each car of the game, and because this circuit controls many car functions. The circuit comprises microprocessor S1D76, which is a model 68HC11 microprocessor (manufactured by Motorola) which operates in split-mode to enable multiplexing with peripheral interface adapter S1D75, a model 68HC24 adapter (manufactured by ASICS). (The 68HC24 is designed to replace the Port B and Port C functions of the 68HC11 MCU. These functions are lost when the MCU is operated in expanded mode.) The 68HC24 enables communication with three additional peripheral interface adapter ports.

Quartz crystal oscillator Y1 and its associated circuit components are arranged to accomplish a plurality of functions. The crystal oscillator is arranged to operate at a frequency of 14.64 MHz. The clock signals are used for communications by both microprocessor S1D76 and by peripheral interface adapter S1D75, and to provide reference clock signals for other game functions. In addition to providing a communications signal, the oscillator also provides a signal for an infrared (IR) baud clock for IR communication.

The crystal oscillator also provides a clock signal to a divide-by-three clock circuit comprising U30 (dual flip-flops), U22 (OR gate), and U14 (Schmitt trigger). This sub-circuit divides the 14.64 MHz by three for other applications within the game. U7 (comprising a plurality of flip-flops) further divides the 4.88 MHz signal from the divide-by-three module to a 38.5 KHz signal for infrared and to a 150 Hz signal for audio within the game. The infrared signal can be used for a “laser tag” aspect of the game where individuals cars can “tag” one another by “laser” IR devices, as in well-known laser tag games.

Code to run the microprocessor is stored in PROM S1D63, a model 29F010 1 MB PROM device. This code is included on the CD software disclosure included with this application, and is included with a commercially available game from Cyber Sport Manufacturing of Amherst, N.Y.

Also connected to the peripheral interface adapter is display driver MAX7219, a standard seven-segment LED driver chip. The driver drives an LED display described infra.

The circuit also includes an MPU (microprocessor unit) support circuit, labeled on the drawing as a Powerup Reset sub-circuit comprising NPN transistor 2N3904 to ensure startup and reset of the main microprocessor and peripheral interface adapter.

Lines PD2 and PC6 communicate with a smaller MPU to perform other functions as described infra.

Also shown on the drawing are radio communication lines RFOUT and RFIN which transmit and receive radio communication signals between the car and host. Examples of information which may be communicated include, but are not limited to, car battery voltage and other car status information. This communication link can also be used to shut a car down in an emergency condition, or if a player in a game is “mis-behaving”. The signals could also be used to cut battery voltage in the car to slow the car down, as in a penalty situation. In a preferred embodiment, the car, which of course is mobile about the playing surface, communicates with the host via a ceiling mounted transceiver. In a preferred embodiment, the transceiver communicates with each car through wireless RF, and the transceiver is hard-wired to the host PC. Of course, other communication schemes are possible. For example, the cars could communicate with the host via IR signals, and the transceiver could wirelessly communicate with the host PC.

Below the RFOUT and RFIN lines are HALF SPEED and EMERGENCY STOP control lines which, as described below, are used to control speed and to stop the car when desired in response to radio control signals. In a preferred embodiment, the EMERGENCY STOP circuit functions to actually operate a main battery contact. When activated, complete battery supply to the car drive motors is interrupted, which completely stops the car. Processor power is not affected by this control.

Below the EMERGENCY STOP control lines are a plurality of ATMEL SELECT lines operatively arranged to control other MPU controllers as additional game features are added.

The circuit also includes a GAME STOP control line which is operatively arranged to stop the game when instructed to do so by the host PC. Unlike the EMERGENCY STOP, the GAME STOP does not interrupt battery power, but simply stops the game in progress. Of course, if for any reason the GAME STOP function fails, the EMERGENCY STOP can be used as a failsafe.

The 38.5 KHz clock is used for a “phaser” function which will permit a “laser-tag” type game to be played. In this version of the game, players will be able to fire a “laser” and tag opposing cars, scoring points, etc.

The circuit also includes a voltage reference sub-circuit V_{REF} which is used as a reference voltage for monitoring car battery voltage. This reference voltage is communicated to the MPU, which compares the reference voltage to the car battery voltage. When a sufficient battery drop is detected/measured, the MPU communicates this fact to the host PC. In this way, the host computer can notify the game operator when a car battery needs to be recharged.

The audio circuit shown in FIG. 18F includes EPROM U18, model 27C160, which stores game sound files. The device has a 2 Mb capacity. The device can hold a total of two minutes of audio files which may be selected as desired. Flip flops U11 start and stop the sounds. The software of the invention generates a byte which selects one of 128 segments of audio stored on the EPROM. The segments are concatenated to fill the length designated by the code. U11 is a counter that counts to the EPROM via lines A1-A13. Signals on lines A14-A20 are used to select specific quadrants of the EPROM. Audio data is transmitted from the EPROM via data lines D0-D7. In a preferred embodiment, the sound signals are amplified by AMP1, and the sounds play through a speaker (S2D71) in the car. Prior to game play, each car is assigned an identification number. The number is communicated via RF or IR signal to the car, and the car audio system will play a predetermined sound to indicate to the referee that the car I.D. has been assigned and acknowledged. The referee can also send a command code to trigger individual sounds to each car. For example, he can send a warning message to a player, or send a congratulatory message when a player scores, etc. Some sounds are manually triggered, while others are automatically triggered. For example, if one player rams his car) into another car, a sensor detects the collision, fault is determined by means of the sensed signal, and the offending player's car can be automatically set to half speed for a predetermined amount of time. Another automatic sound, for example, may tell the driver that his battery needs to be recharged. A sound may tell the player “great shot” when he scores, for example.

In a preferred embodiment, the cars are each powered by a 24 VDC battery, rated at 130 amp-hours. This battery voltage is divided by divider circuits well known in the art to provide 15 VDC, and 5 VDC, to power electronics on each car. In some situations, it may be necessary to stop play, limit car speed, or to completely disable all cars. Shown in FIG. 18U is emergency stop relay K2 which controls the aforementioned emergency stop contactor coils. FIGS. 18S and 18T show the half speed relay K1 and the game stop relay K3. As described previously, these relays are used to limit car speed to half speed when desired, for example, when a player commits a penalty; or to stop game play, respectively. Emergency stop relay K2 can be used during an emergency, for example, if a player leaves his car and starts to walk across the play surface during a game. Emergency stop relay K2 breaks contact between the car's battery and motor, preventing motion. Half-speed relay K1 provides half-voltage to the player's joystick, preventing him from applying more than half voltage to the car motor controller. Game stop relays removes all voltage from the player's joystick, preventing application of a voltage to the motor controller, but does not break the main contacts to the motor.

FIG. 18J shows peripheral interface processor S3D103 (Model AT90S2313 by Atmel or equivalent), which is used to control a plurality of multi-colored LED displays located within each car. In a preferred embodiment, each car includes red, blue and white LEDs. These LEDs can serve a number of functions. For example, a number of blue LEDs can be activated on a number of cars to designate a “blue” team; a number of red LEDs can be activated to designate a “red” team, etc. The LEDs can also be programmed to flash during certain game events, such as a score, for example, to add excitement, or even to dim/turn off when a player is penalized, for example. Also, in a “laser-tag” version of the car, a white LED may flash to indicate that a player successfully “tagged” an opposing player's car.

FIGS. 18W and 18X also show laser drive circuit LS1 which controls the laser on the phaser gun of the invention. This circuit controls the laser duration and limits it to 0.21 sec bursts in duration. Again, the phaser is used in a “laser-tag” version of the game of the present invention. FIG. 18X also shows IR communication circuit IR1 which modulates the 38.5 KHz IR communication signal. This signal is used for communication between cars. For example, it is used to indicate which car tagged another car during game play. Finally, FIGS. 18H-18K show LED displays DI0-DI7 which are mounted in each car and arranged to display various game parameters, such as team score, time left, shots on goal, etc.

FIGS. 18A-18Y illustrate a goal control circuit. In a preferred embodiment of the game, the host control circuit is mounted inside the goal unit, and hard-wired to the host PC. Of course, the goal control circuit could be connected wirelessly to the host PC. This control circuit processes commands sent from the host PC to control sounds from the main game speakers, and to control the scoreboard, etc. For example, the control circuit can send both scores and time remaining information to the scoreboard when commanded to do so by the host PC.

As seen in the drawings, the goal control circuit is virtually identical to the car control circuit. The quartz crystal timing circuit and divide-by-three circuits, and audio clock signals are identical and perform the same function. The host control circuit includes a microprocessor S1D65 which is also a 68HC11 device, and a peripheral interface adapter S1D77 which is a 68HC24 device. The circuit also includes PROM S1D96, a 29F010 PROM, which stores the code to run the microprocessor. This code has been provided to the United States Patent and Trademark Office on CD ROM and is to be considered a part of the specification.

Shown in FIG. 19C and 19D is power supply PS1 which provides 9 VDC for LEDs and 5 VDC supplies to run the various electronic components.

The host circuit also includes audio circuit AMP2 comprising EPROM U19, model 27C160, which stores game sound files. The device has a 2 Mb capacity. The device can hold a total of two minutes of audio files which may be selected as desired. Flip flops U12 start and stop the sounds. The software of the invention generates a byte which selects one of 128 segments of audio stored on the EPROM. The segments are concatenated to fill the length designated by the code. U12 is a counter that counts to the EPROM via pins A2-A13. Signals on lines A14-A20 are used to select specific quadrants of the EPROM. Audio data is transmitted from the EPROM via data lines D0-D7. In a preferred embodiment, the sound signals are amplified by circuit AMP2, and the sounds play through four speakers (S2D71) located in the corners of the playing area proximate the ceiling. Some sounds are manually triggered, while others may be automatically triggered. For example, the referee may manually trigger a sound to be played when a goal is scored, or sensors in the goal enclosure may sense a goal and play a sound.

The host computer communicates with the goal circuit via RS-485 ribbon cable or by RF communication depending on how the game is configured. If communicating by hard wire, then sub-circuit RS-485 on FIGS. 19T and 19U is used. If communicating by radio, then sub-circuit RADIO is used. The RS-485 sub-circuit uses a 75176 chip for TTL data communication with the processor. The RS-485 and radio circuits are arranged in parallel. If the radio is not connected, then communications occur via hard-wire over the RS-485 cable. If the radio is connected, then RS-485 communications are disabled. The goal circuit also includes a strobe light sub-circuit STROBE which may be configured to fire a strobe light during game play. For example, the software can fire the strobe either automatically upon a score, or be fired manually by the referee.

The goal circuit also includes two microcontrollers U19 and U26 as shown on FIGS. 19G and 19K. In a preferred embodiment, each of these microcontrollers is an Atmel Model AT90S2313 8-bit microcontroller with 2K bytes of in-system programmable flash. As seen in the schematic, the controllers are arranged to fire a plurality of different colored LEDs. For example, the drawing shows a plurality of red, blue and green LEDs. The various LEDs are shown on the drawing using the conventional electronic symbol for an LED, and the control lines are labeled RED, GRN, BLU to designate red, green and blue; or RED1, GRN1 and BLU1 to designate red, green and blue, respectively. The individual LEDs are further labeled LS4-LS30. The multi-colored LEDs are physically located on each goal. They can serve a number of purposes. For example, the LEDs may light up on their respective goals corresponding to the team trying to score there. Also, the LEDs can be programmed to flash during certain game events, such as a score, to add excitement, or even to dim/turn off when game play is paused, for example.

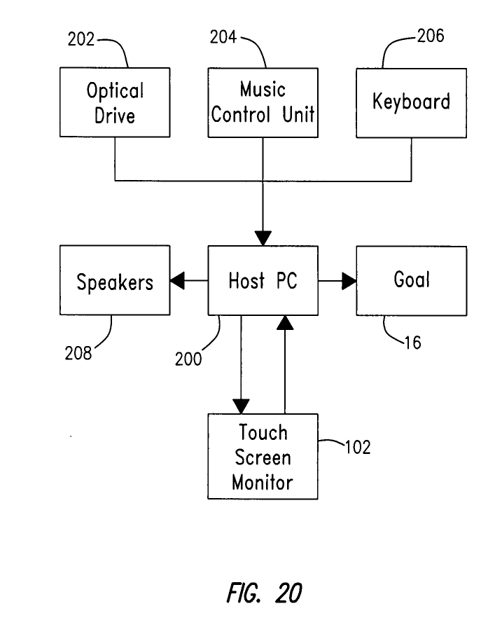

The goal circuit also includes dipswitch DIPSWHEXV which identifies the goals to the host computer. This enables the host PC to know which goal has registered a goal/score. FIGS. 20 and 21 are composite diagrams of FIGS. 18A-18Y and 19A-19Y, respectively detailing the arrangement of the figures in viewing the electrical schematics.

### Host PC Operation

In the drawings and written description of the invention, we utilize screen captures taken while operating the software to illustrate the best mode of the invention known to the inventors at the time of application for patent and to enable those having ordinary skill in the art to use the invention. The software of the present invention was written in C and is operatively arranged to operate in MS-DOS. It should be understood that the present invention is not limited to any particular operating system and may for example, be compatible with any DOS based system, Windows XP, Windows Vista, Unix, Mac OS, or any other operating system. Likewise, the software does not have to be written in C, but could be written instead in Visual Basic, Java, or any other programming language known in the art.

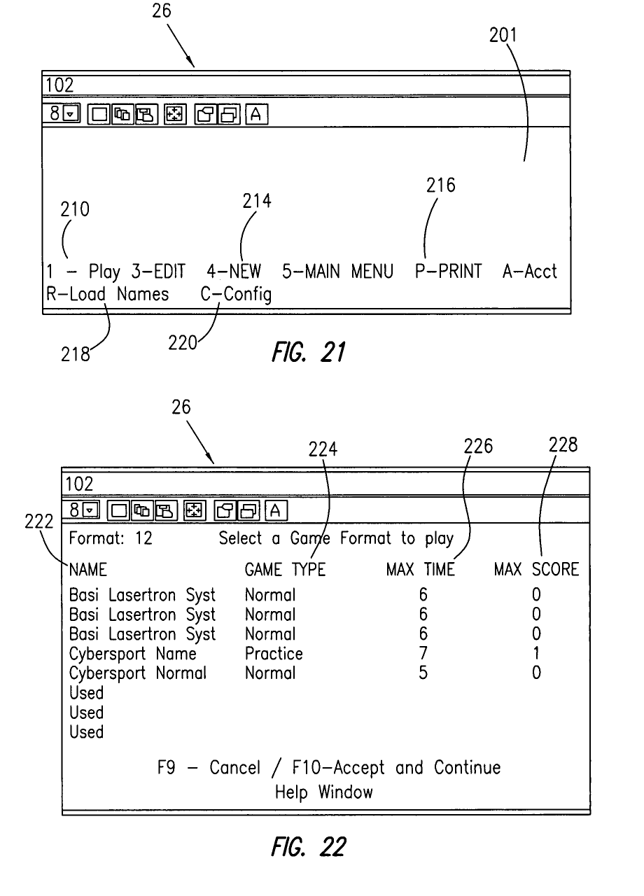

FIG. 22 is a block diagram illustrating a present invention control terminal 26 for controlling game 10. Control terminal 26 includes host pc 200, which is operatively arranged to receive inputs from optical drive 202, music control unit 204, keyboard 206, and touch screen monitor 102. Typically, host PC 200 is a general-purpose computer, however it should be understood that host PC 200 can be any computer or computing system known in the art, and that such modifications are within the spirit and scope of the claims. Host PC 200 is also operatively arranged to output signals to speakers 208, goal 16, and touch screen monitor 102. It should be understood that touch screen monitor 102 could be replaced with a standard non-touch monitor and the use of a mouse or voice command system could be used in place of a touch screen operation as these modifications are within the spirit and scope of the claims.

Optical Drive 202 is an optical unit which is primarily used to play music during game play, however optical drive 202 could be used for software updates and recording of player or game statistics. In a preferred embodiment, optical drive 202 is a compact disk drive. In the alternative, optical drive 202 could be a Digital Video Disk drive, Blue-Ray disk drive, or a re-writable compact disk drive. Music control unit 204 includes volume control, a microphone input, and track selection controls. Keyboard 206 is a standard keyboard, however any control unit known in the art could be used to select the appropriate commands as required by the computer. Touch screen 102 further allows the referee to control host pc 200 by pressing various control buttons on touch screen 102 as will be described infra.

Control terminal 26 also includes outputs to speakers 208, touch screen monitor 102, and goal 16. Speakers 208 are located within play area 12 and arranged to reproduce music from optical drive 202, voice commands from music control unit 204, and sounds stored on a storage unit of host pc 200, such as a hard drive or universal serial bus flash drive. Touch screen monitor 102 is operatively arranged to receive and display commands from host PC 200, therefore touch screen monitor 102 maintains two-way communication with host pc 200. Goal 16, which may include lights in the form of LEDs or speakers, is operatively arranged to be controlled by host PC 200. Such that when the referee depresses a certain button on touch screen monitor 102, lights in goal 16 may light up or flash, or a sound may be reproduced through speakers on goal 16. In addition, goal 16 may be operatively arranged to send information to host PC 200, which may also then be displayed on touch screen monitor 102. Information sent to host PC 200 may include scoring a goal.

The operation of control terminal 26 will now be described adverting to FIGS. 23-28. FIG. 23 is a screen capture illustrating operation mode selection menu 201. The referee can select from various operation modes including play 210, edit 212, new 214, print 216, load names 218, and configuration 220. The operation mode selection can be made by pressing the appropriate button on keyboard 206 or touch screen monitor 102. Host PC 200 is operatively linked to a wireless or wired network where players input their real name and code name. When setting up a game, host PC 200 receives the current list of real names and code names from the network. New 214 erases the current list of real names and codes names within memory of host PC 200 and communicates with the network to receive a replacement set of real names and code names when the referee selects load names 218. Print 216 is arranged to allow the referee to print past game statistics, whereby the referee can print the player and game statistics of any game played which is still in host PC 200 memory.

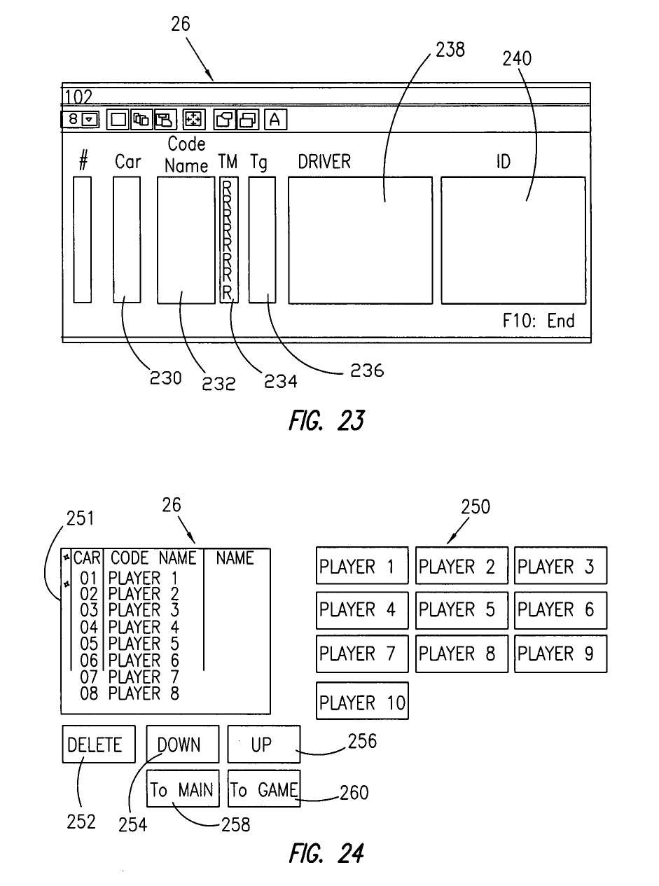

FIG. 24 is a screen capture illustrating a game format selection prompt which is accessible by selecting configuration 220 from the operation mode selection prompt. In configuration mode, the referee selects the appropriate game format by game name 222 and game type 224. Maximum time 226 and maximum score 228 are displayed for each game format. For example, when game type 224 is practice, maximum time 226 may be seven minutes and maximum score 228 may be one goal. The referee may use keyboard 206 to scroll to the proper game name or touch screen monitor 102 to select the proper game name. If using keyboard 206, the referee may press the F9 key to cancel the game change or press the F10 key to accept the highlighted game and exit the configuration mode. However, it is within the spirit and scope of the present invention to operatively change game name 222, game type 224, maximum time 226, and maximum score 228 from the configuration mode by pressing the appropriate game name and modifying the desired parameters with the keyboard or the touch screen monitor.

FIG. 25 is a screen capture illustrating player edit mode 212. Player edit mode 212 allows the referee to operatively change user information such as car number 230, code name 232, team color 234, team goal 236, driver name 238, and user identification number 240. Player edit mode 212 loads player information within host PC 200 so that the referee can move the cursor to the appropriate player to change each individual player's car number 230, team color 234, and team goal 236. In a preferred embodiment, there are two team colors, red and blue, as well as two team goals. However, it is within the spirit and scope of the invention to provide more than two team colors and more than two goals, thereby requiring selection of the appropriate team color 234 and team goal 236. The referee can change any of the user information as mentioned supra with keyboard 206 or touch screen monitor 102.

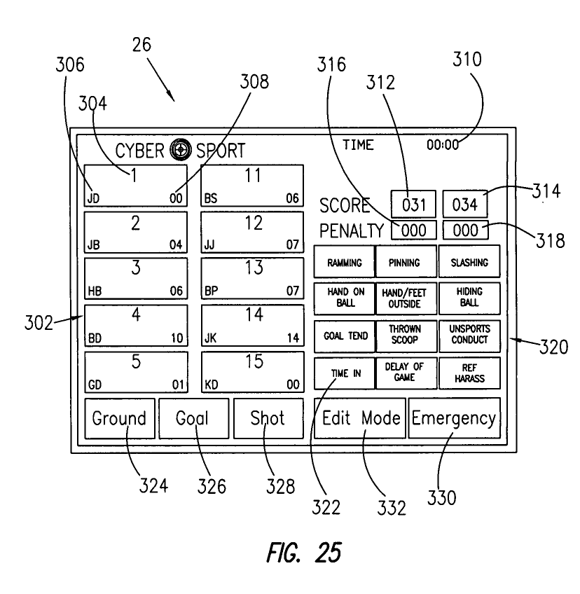

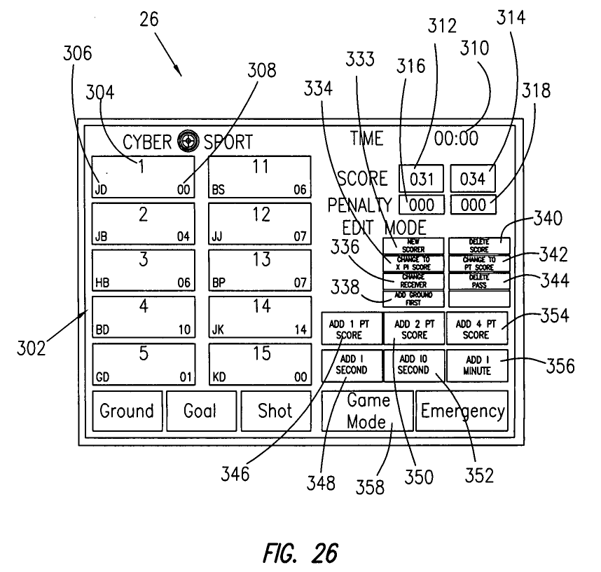

FIG. 26 is a screen capture illustrating player designation mode accessed through operation mode selection menu 201 via load names 218. Player designation mode also includes navigation buttons delete 252, down 254, up 256, to main 258, and to game 260. In addition, player names are represented by player name buttons 250 loaded into memory of host pc 200 are displayed on touch screen monitor 102. In some aspects, the referee may double-click a player name button and edit the player name with a keyboard or touch screen monitor 102 to load players into the appropriate corresponding car, by load we mean placing the player name with the appropriate car. Down 254 and up 256 control cursor 251 which is represented as a star in play list 253. The referee presses down 254 until the appropriate car is selected. For example, to place a player in car two, the referee will press down 254 or up 256 until cursor 251 is located on the same line as car two. If a player is already loaded in car two, the referee can press delete 252 to remove the player from car two. Once car two is empty, the referee will press a player name button 250, which will place the player code name and real name on the car two line. The above process is repeated until the correct players are located in the correct cars and any non-players are removed from play list 253. Once play list 253 is correct, the referee may select to main 258, which will return the referee to operation mode selection menu 201. If to game 260 is selected, the referee will be taken to active play mode as described infra.

FIG. 27 is a screen capture illustrating an active play mode accessed through operation mode selection menu 201 via play 210 or to game 260. Active play mode is the main game play mode and the mode in which the referee controls the aspects of play. Current player buttons 302 include car number 304, player initials 306, and player points 308. The number of current player buttons 302 corresponds to the number of players currently playing game 10. Current player buttons 302 are touch sensitive so that each player can be identified, statistics kept, and penalties assessed. The active play mode further includes timer 310 which is operatively arranged to countdown from a predetermined time limit. Timer 310 corresponds to game clock 24 so that any changes made to timer 310 are also made to game clock 24. Each team has a score box 312 and 314, as well as a penalty box 316 and 318. Score boxes 312 and 314 correspond to scoreboard scores 25a and 25b.

The referee can press penalty buttons 320 to assess penalties for a variety of infractions, including: ramming, pinning, slashing, hand on the ball, hand or feet outside of the vehicle, hiding the ball, goaltending, throwing the scoop, unsportsmanlike conduct, delay of game, or harassing the referee. However, it should be noted that any other penalties are within the spirit and scope of the present invention. In addition, time in 322 is operatively arranged to activate timer count down 310 as well as rename button 322 to display “time out.” By this we mean that when play is active, button 322 reads “time out” and upon depressing “time out,” the power to the vehicles is turned off and timer 310 stops. When play is inactive, either before the game begins or due to a “time out,” button 322 reads “time in” and pressing the button will activate timer 310 and the vehicles for play.

The active play screen also includes ground 324, goal 326, and shot 328. When the referee presses ground 324, the next player to posses the ball will receive a “pick-up” statistic, meaning that the player picked the ball up from the ground. When the referee presses goal 326, the player who currently posses the ball will be awarded a goal and the team score box 312 or 314 will increase by the appropriate number of points. When the referee presses shot 328, the player who currently possesses the ball will be awarded a shot. Passes and steals between players are also kept in the statistics. To record a pass, the referee presses current player button 302 of the player who has the ball and then presses the player number of the player who received the pass or intercepted the pass. If the players are on the same team, the catch will be considered a pass. If the players are on opposing teams, the catch will be considered a steal. Advantageously, this arrangement allows the referee to press only one button to both statistically note the pass or steal and to note who currently possesses the ball.

In a preferred embodiment, when the referee presses ground 324, goal 326, shot 328, passes between players, or assessing penalties activates speakers through host PC 200 to announce appropriate messages such as “nice pass” or “goal.”

If a penalty occurs during game play, the referee will press the appropriate penalty button 320 followed by the current player button 302 of the offending player. After pressing current player button 302, all vehicles are stopped for a predetermined time, preferably seven seconds, and both a point and possession of the ball are awarded to the non-offending team. In alternative embodiments, the vehicles remain active and only the offending player is penalized by a reduction of speed. By this, we mean that the speed of the offending player is set to a maximum of one-half or one-third of full speed for a given period of time. Once penalty time has elapsed, the offending player will again travel at normal speed.

In a preferred embodiment, when a penalty occurs and the referee presses the appropriate penalty button 320 followed by the corresponding current player button 302, a personal message may be sent to the individual who committed the penalty through speakers which are on-board the player's vehicle. The message may detail what penalty the player committed, as well as informing the player that he or she is now at one-half speed or that a point has been awarded to the other team.

The active play screen also includes emergency 330 and edit mode 332. If an emergency occurs during game play, the referee will press emergency 330 which will deactivate all the vehicles by removing power and will require a manual reset of each vehicle before operation can continue. If the referee presses edit mode 332, active play continues in play area 12 and timer 310 continues to countdown, while touch screen monitor 102 displays the edit mode as described infra.

FIG. 28 is a screen capture illustrating edit play mode which is accessible from active play mode by pressing edit mode 332. Edit play mode includes the same. current player buttons 302, timer 310, score boxes 312 and 314, and penalty boxes 316 and 318. In addition, the edit play mode also includes the ground, the goal, the shot, and the emergency buttons of the active play mode. Edit play mode is operatively arranged to allow normal play to continue while changes can be made to the score, time remaining, or statistics.

Edit play mode also includes new scorer 333, change to x player score 334, change receiver 336, add ground first 338, delete score 340, change to point score 342, and delete pass 344. In order to change which player is credited with points, the referee presses new scorer 333 followed by the corresponding current player button 302 of the correct player. When the referee presses change to x player score 334, the referee then presses the corresponding current player button 302 and increases the player's score with buttons 346, 350, or 354 depending upon the point increase desired. Add one point 346, add two points 350, and add four points 354 increase individual and team scores respectively. However, one of ordinary skill in the art should immediately recognize that any combination of point increases or decreases could replace buttons 346, 350, and 345. When the referee presses change receiver 336, the last pass is deleted from the player statistics and replaced with a new pass directed to the player whose current player button 302 is pressed. For example, if player one passed to player two, but the referee inadvertently pressed player three as the receiver, by pressing change receiver 336 then player two current player button 306, the incorrect pass will be removed and the correct pass included.

When the referee presses add ground first 338, the last pass will be removed and a “pick up” will be included for the player who had received the incorrect pass. When the referee presses delete score 340, the last goal issued by the referee is removed from the player statistics and the respective score box 312 or 314. When the referee presses change to point score 342, the team score and statistics of the player are increased after the referee presses the corresponding current player button 302 and the appropriate point increase button 346, 350, and 354. When the referee presses delete pass 344, the last pass is removed from the player statistics.

Edit play mode also includes timer increase buttons 348, 352, and 356, which add one second, ten seconds, and one minute to timer 310, respectively. Finally, game mode 358 is operatively arranged to place the referee in active play mode and exit from edit play mode.

Thus, although in a preferred embodiment the referee inputs actions such as goals, shots, passes, penalties, etc., by pressing buttons, it is within the spirit and scope of the present invention to provide functions that the referee normally controls, such as scoring goals, by means of sensors. The sensors could be lasers or push buttons. If lasers are used, once a ball breaks the laser's beam path, a point is automatically awarded to the proper team as opposed to the referee pressing goal 326.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A game, comprising:
a court having a plurality of walls extending upwardly from a floor defining a play area;
a game piece;
at least one target positioned on a wall of said plurality of walls, said target comprising a plurality of multi-planar apertures operatively arranged to receive said game piece; and,
a vehicle, operatively arranged to be driven by a player.

2. The game recited in claim 1, wherein said game further comprises a padded skirt engaged to at least one wall of said plurality of walls and said floor, so that said padded skirt is located along a portion of a perimeter of said floor.

3. The game recited in claim 2, wherein said vehicle further includes a bumper, and said bumper of said vehicle slidably engages with said padded skirt.

4. The game recited in claim 2, wherein said padded skirt is operatively arranged to deflect said game piece away from said plurality of walls into said play area.

5. The game recited in claim 2, wherein said padded skirt further comprises:
a sloped portion positioned proximate said plurality of walls;
a bumper, positioned at an end of said sloped portion including an inner cushioning potion and a smooth, flexible outer portion.

6. The game recited in claim 5, wherein said inner cushioning portion is a dense foam rubber.

7. The game recited in claim 5, wherein said smooth, flexible outer portion is a resilient smooth rubber membrane operatively arranged to encase said inner cushioning portion.

8. The game recited in claim 3, wherein said bumper further comprises an inner cushioning portion and a smooth, flexible outer portion.

9. The game recited in claim 8, where said inner cushioning portion is a dense foam rubber.

10. The game recited in claim 8, wherein said smooth flexible outer portion is a resilient smooth rubber operatively arranged to encase said inner cushioning portion.

11. The game recited in claim 1, wherein said vehicle comprises:
a base;
a seat positioned atop said base;
a movement control device positioned atop said base and in front of said seat; and,
a bumper positioned circumferentially about said base, and wherein said movement control device is operatively arranged to control a turning means of said vehicle and a drive means of said vehicle.

12. The game recited in claim 1, wherein said game further comprises a control terminal.

13. The game recited in claim 12, wherein said vehicle further comprises a means for wirelessly communicating with said control terminal, and wherein said control terminal further comprises a means for wirelessly communicating with said vehicle.

14. The game recited in claim 12, wherein said control terminal comprises means for recording and displaying at least one characteristic of said game.

15. The game recited in claim 14, wherein said at least one characteristic of said game is selected from the group consisting of: scores, shots on goal, rebounds, assists, penalties, player names, and time.

16. The game recited in claim 14, wherein said at least one characteristic of said game is entered into said control terminal by means of a touch-screen monitor.

17. The game recited in claim 12, wherein said control terminal comprises means for operating an audiovisual output.

18. The game recited in claim 17, wherein said audiovisual output of said game comprises a pre-recorded message.

19. The game recited in claim 12, where said control terminal comprises a means for calculating at least one statistical characteristic of said game.

20. The game recited in claim 12, wherein said control terminal comprises a means for controlling a drive means of said vehicle.

21. The game recited in claim 20, wherein said means for controlling said drive means of said vehicle is operatively arranged to control a rate of movement of said vehicle.

22. The game recited in claim 20, wherein said vehicle is a plurality of vehicles, and said control terminal means for controlling said drive means of said vehicle can individually control each of said vehicles.

23. The game recited in claim 1, wherein said game piece is spherical.

24. The game recited in claim 1, wherein said game piece is ellipsoidal.

25. The game recited in claim 1, wherein said game piece is a disk.

26. The game recited in claim 1, further comprising a scoop operatively arranged to be held by said player for catching, throwing, and retrieving said game piece, wherein said scoop includes a handle portion and a basket portion.

27. The game recited in claim 1, wherein said at least one target comprises three multi-planar apertures operatively arranged to accept said game piece.

28. The game recited in claim 1, wherein said at least one target has a semi-circular perimeter.

29. The game recited in claim 11, wherein said movement control device is located substantially equidistant from a left side and a right side of said vehicle.

30. The game recited in claim 1, wherein said at least one target has a rectangular perimeter.

31. The game recited in claim 1, wherein said at least one target has a trapezoidal perimeter.

32. The game recited in claim 1, wherein said at least one target comprises a first aperture of a circular shape having a first diameter and positioned about a first plane, and a second aperture having a circular shape having a second diameter and positioned about a second plane, wherein said second diameter is greater than said first diameter.

33. The game recited in claim 11, wherein said vehicle further comprises a turning means.

34. The game recited in claim 11, wherein said movement control device of said vehicle is capable of varying a rate of speed and a rate of turning of said vehicle.

35. The game recited in claim 11, wherein said movement control device is a joystick.

36. The game recited in claim 11, wherein said movement control device is a trackball.

37. The game recited in claim 1, wherein said vehicle is self-propelled and said vehicle further comprises an on-board power supply.

38. The game recited in claim 37, wherein said on-board power supply comprises a battery.

39. The game recited in claim 38, wherein said vehicle further comprises a means for monitoring said battery's charge level.

40. The game recited in claim 11, wherein said vehicle further comprises a protective shroud around said movement control device.

41. A game, comprising:
a floor;
a plurality of walls rising up from said floor, wherein said plurality of walls comprises a first pair of parallel walls and a second pair of parallel walls, where said first set and said second set of parallel walls engage to generally define a rectangular play area, and wherein said play area has a first end and a second end, where said first end is opposite from said second end;
a padded skirt engaged to said plurality of walls and said floor along a substantial portion of a perimeter of said floor;
a game piece;
a first target positioned proximate said plurality of walls at said first end, comprising a plurality of multi-planar apertures operatively arranged to accept said game piece, wherein an aperture of said plurality of apertures is facing said second end;
a second target positioned proximate said plurality of walls at said second end, comprising a plurality of multi-planar apertures operatively arranged to accept said game piece, wherein an aperture of said plurality of apertures is facing said first end;
a vehicle, comprising a base, a seat, a movement control device positioned atop said base and in front of said seat and located substantially equidistant from a left and a right side of said vehicle, a shroud positioned about said movement control device, a power supply, and a bumper, wherein said movement control device is operatively arranged to electronically control a drive means of said vehicle; and,
a control terminal, wherein said control terminal comprises means for recording and displaying at least one characteristic of said game, means for remotely controlling said drive means of said vehicle, and means for operating an audiovisual output related to said game.

42. A vehicle comprising:
a base;
a seat located atop said base;
a bumper affixed around at least a portion of said base; and,
a movement control device positioned atop said base and in front of said seat and located substantially equidistant from a left and a right side of said vehicle, and wherein said movement control device is operatively arranged to electronically control a drive means and a turning means of said vehicle.

43. A joystick system comprising:
a joystick; and,
a shroud encircling said joystick, wherein said joystick has a first height, and said shroud has a second height, said first height is less than or equal to said second height.

44. The joystick system recited in claim 43 wherein said joystick system is mounted on a vehicle and operatively arranged to control the movement of said vehicle.

45. A bumper skirt system comprising:
a court having a floor and a plurality of walls encasing at least a portion of said floor;
a skirt engaged to said floor and said plurality of walls around at least a portion of a perimeter of said floor, wherein said skirt is sloped downwardly away from said plurality of walls for deflecting an object which lands on said skirt away from said plurality of walls, and wherein said skirt terminates in a bumper;
wherein said bumper comprises an inner cushion and an outer membrane, and wherein said outer membrane is operatively arranged to encase said inner cushion.

46. The bumper skirt system recited in claim 45 wherein said inner cushion is a dense foam rubber, and said outer membrane is a smooth, flexible, and resilient rubber.

47. The bumper skirt system recited in claim 45 further comprising a vehicle operatively arranged to maneuver around said court, wherein said vehicle has a vehicle bumper, where said vehicle bumper includes a vehicle bumper cushion and a vehicle bumper membrane, and wherein said vehicle bumper membrane on said vehicle bumper slidably engages with said bumper on said skirt upon impact between said vehicle and said bumper skirt system.

48. A vehicle bumper system comprising:
a vehicle having a base;
a bumper secured around at least a portion of said base, wherein said bumper comprises an inner cushion and an outer membrane, and wherein said outer membrane is operatively arranged to encase said inner cushion.

49. The vehicle bumper system recited in claim 48, wherein said inner cushion is a dense foam rubber, and said outer membrane is a smooth, flexible, and resilient rubber.

50. A game, comprising:
a floor;
a plurality of walls rising up from said floor defining a play area;
a game piece;
at least one target positioned proximate said plurality of walls, comprising a hoop and a backboard, wherein said hoop is arranged in a substantially horizontal orientation and said backboard is arranged in a substantially vertical orientation;
a vehicle operatively arranged to be driven by a player;
a control terminal operatively arranged to remotely control a drive means of said vehicle.

51. The game recited in claim 50, wherein said control terminal remotely controls a rate of speed of said drive means of said vehicle.
